(19) United States
(12) Patent Application Publication
(10) Pub. No.: US 2026/0127691 A1
(43) Pub. Date: May 7, 2026

(54) MANAGEMENT SYSTEM

(71) Applicant: Bao Tran, Saratoga, CA (US)

(72) Inventor: Bao Tran, Saratoga, CA (US)

(21) Appl. No.: 18/935,522

(22) Filed: Nov. 2, 2024

(51) Int. Cl. G06Q 50/18; G06F 40/166; G06F 40/279; G06F 40/40; G06V 30/19; G06V 30/422

(52) U.S. Cl. CPC G06Q 50/184; G06F 40/166; G06F 40/279; G06F 40/40; G06V 30/19; G06V 30/422

(57) ABSTRACT

The disclosed computer-implemented method streamlines the creation of non-provisional patent applications and the response to patent office actions. For generating patent applications, the method automates the extraction and labeling of images from scientific texts, creating comprehensive patent specifications through a language model that integrates claims, descriptions, and drawings. The system offers editing interfaces, supports patentability assessments, and formats the final output to meet various requirements, resulting in ready-to-file patent applications. For office action responses, it involves an automatic analysis of the content, comparison with historical data from similar cases, and crafting arguments using insights from the examiner's record and past successful strategies.

### BACKGROUND OF THE INVENTION

This application is related to US20230252224A1 and to Serial ______, the contents of which are incorporated by reference.

According to the AUTM Licensing Survey, academic research contributing to new commercial products, with 714 products reaching the market in 2023. Total research expenditures grew to $104 billion in 2023, the highest in the survey's 30-year history, marking a 13% increase from 2022. Federal funding rose more than 10%, while industry support grew 4% over the prior year. License income was reported at $3.6 billion, slightly down from the $3.8 billion peak in 2022. Technologies developed by universities and research institutions led to the launch of 714 new commercial products. Over 25,000 invention disclosures were reported to institutions in 2023, contributing to a cumulative total of more than half a million disclosures. Nearly 3,000 patent licenses, over 3,200 copyright licenses, and more than 1,600 other types of licenses were recorded in 2023.

The realm of intellectual property, specifically patents, is a and nuanced process often fraught with procedural intricacies and specialized discourse. Within this space, university researchers and licensing practitioners navigate complex interactions with patent filings where the translation of scientific discoveries into patent applications involves both a deep understanding of the underlying technology and an ability to express highly technical concepts in the confines of a structured legal document. After filing, the inventors encounter office actions that require and informed responses. Further, inventors face difficulty in licensing their inventions.

### SUMMARY OF THE INVENTION

In one aspect, the method involves a computer-based process that receives a scientific publication as input and generates a non-provisional patent application. The process extracts images from the scientific publication, and assigns brief descriptions to these images using associated text from the publication. A multimodal language model is used to identify and label components or reference signs within the images. The system creates patent claims based on the publication's contents, which are then shown to a user for validation. Once the user has edited/approved the draft, a large language model drafts the patent application as guided by the claims and the reference signs in each drawing. The method acts as a copilot under complete control of the user and creates the application based on the user approved/edited claims, images provided by the user in the publication, the brief description of the drawings, and labeled parts or reference signs provided by the user in the publication. The result is a non-provisional patent application including a background section, a summary based on the claims, drawings with descriptions, a detailed description of one or more implementations, and the set of claims, all of which are fully human controlled.

In yet another aspect, the method involves a computerized approach to handling a patent office action by receiving the action, analyzing it to identify rejections and cited references, querying a database for the patent examiner's history, finding similar past rejections that involve the same references, reviewing successful arguments that overcame those rejections, formulating a response incorporating these arguments, and then outputting the crafted response.

Advantages of one implementation may include one or more of the following:

Automation Efficiency: One implementation dramatically increases the efficiency of patent application preparation and office action responses. By automating the initial draft and response processes, one implementation reduces the time patent practitioners spend on repetitive and time-consuming tasks, allowing them to focus on higher-level strategic aspects of patent prosecution.

Consistency and Accuracy: By employing historical data on successful arguments and leveraging pre-existing successful response templates, one implementation ensures consistency and improves the accuracy of office action responses. This can potentially lead to higher acceptance rates for patent applications.

Reduction of Human Error: The method minimizes the risk of human error that can occur with manual patent drafting and office action analysis. By utilizing natural language processing and machine learning algorithms, one implementation can identify details and generate legal and technical language.

Cost-Effectiveness: Automation of the patent drafting and office action response processes may reduce the cost associated with these activities. This reduction in labor time and effort can translate into lower fees for clients seeking patent protection.

Enhanced Patent Quality: The systematic approach of one implementation in drafting patent applications can result in higher-quality patents. By ensuring thorough consideration of patent claims and adherence to legal requirements, the technology can mitigate potential grounds for invalidation that might otherwise be overlooked.

Scalability: One implementation can process large volumes of data, ranging from office actions to scientific articles, at an unprecedented scale compared to manual analysis. This attribute allows for handling multiple patent filings simultaneously while maintaining consistency across various applications.

Customized Responses: The system's ability to tailor responses based on the specific history and tendencies of individual patent examiners can increase the likelihood of overcoming rejections and obtaining favorable outcomes.

Intellectual Resource Management: Patent practitioners can more effectively manage their intellectual resources, using the system to free up time for activities and facilitate the leveraging of existing intellectual capital for the drafting of new applications and the advancement of clients' patent portfolios.

Comprehensive Legal and Technical Analysis: One implementation merges the technical understanding required to digest scientific concepts with the legal expertise necessary to navigate patent law, thereby providing a comprehensive analysis that bridges two complex fields.

Global Applicability: The method can be adapted to meet the needs and requirements of different patent systems around the world, thus enabling a more streamlined process for global patent strategy and filings.

Real-time Updates and Learning: As the system processes more office actions and patent draftings, it continually updates its database and learns from new data, ensuring that the responses and patent applications are based on the most current and relevant information.

The combination of these advantages results in a tool that significantly enhances the patent drafting and prosecution process, reducing barriers for entry for innovators, and improving the overall quality and reliability of patent applications across the industry.

In another aspect, the method employs an AI system to enhance patent licensing and infringement analysis by processing patent claims, extracting key features using natural language techniques, creating structured claim charts, conducting infringement analysis, identifying potential licensees or infringers, and crafting tailored outreach materials, all of which can be distributed through various marketing channels including chat, email, or ads.

The AI-driven approach to patent licensing and infringement analysis provides several advantages, which include but are not limited to:

Increased Efficiency: The use of AI can significantly reduce the time required to perform complex patent analyses. By automating the extraction of key features and creating structured claim charts, the time spent on these tasks is minimized, resulting in a faster process from patent analysis to decision-making.

Improved Accuracy: AI systems can leverage machine learning algorithms and natural language processing techniques to understand and analyze patent claims with a high degree of precision. This reduces the likelihood of errors that can occur due to manual oversight or misinterpretation of complex technical language.

Scalability: The AI-driven system can handle large volumes of patents without the need for proportional increases in human resources. As the number of patents continues to grow, scalability becomes increasingly important for organizations that need to manage extensive patent portfolios.

Cost-Effectiveness: Automating patent analysis tasks can lead to significant cost savings by reducing the need for a large team of analysts and legal professionals. This can make patent portfolio management more accessible for smaller entities or individual inventors.

Strategic Insight: With enhanced data analytics capabilities, the AI system can provide valuable insights into potential licensees or infringers. It can also offer strategic recommendations based on patterns and trends identified through its analysis.

Proactive IP Management: One implementation allows for proactive management of intellectual property by enabling continuous monitoring of the patent landscape for potential infringing activities and licensing opportunities.

Tailored Outreach: The system can generate customized materials for reaching out to potential licensees or infringers, thus increasing the likelihood of a successful licensing agreement or resolution of infringement issues.

Enhanced Communication: By producing clear and structured claim charts and analysis reports, the AI system facilitates better communication among stakeholders, legal counsel, and during negotiations or litigation.

Global Application: The AI system can be trained to handle patents from different jurisdictions, taking into account various legal frameworks and languages, thus offering a tool with global applicability.

Dynamic Updating: The AI system can continually learn from new data, legal decisions, and user feedback, thereby improving its performance and accuracy over time, and ensuring that it remains up-to-date with the latest developments in patent law and technology.

By incorporating these advantages, one implementation represents a transformative step in patent management, providing resources to better protect and capitalize on intellectual property in an ever-evolving technological landscape.

### BRIEF DESCRIPTION OF DRAWINGS

FIG. 1A shows flowchart illustrating the process of automated patent application generation and response formulation.

FIG. 1B-1D show exemplary UI for the system of FIG. 1A.

FIG. 2 shows flowchart detailing steps for downloading references, providing them to an LLM, and applying MPEP rules.

FIG. 3 shows flowchart depicting a process for automated patent application response, including steps like analyzing office actions and querying databases.

FIG. 4A shows an exemplary system for licensing IP.

FIGS. 4B-4D show exemplary UI for the system of FIG. 4A.

FIGS. 5A-5C show exemplary LLMs as detailed in commonly owned US20230252224A1, the content of which is incorporated by reference.

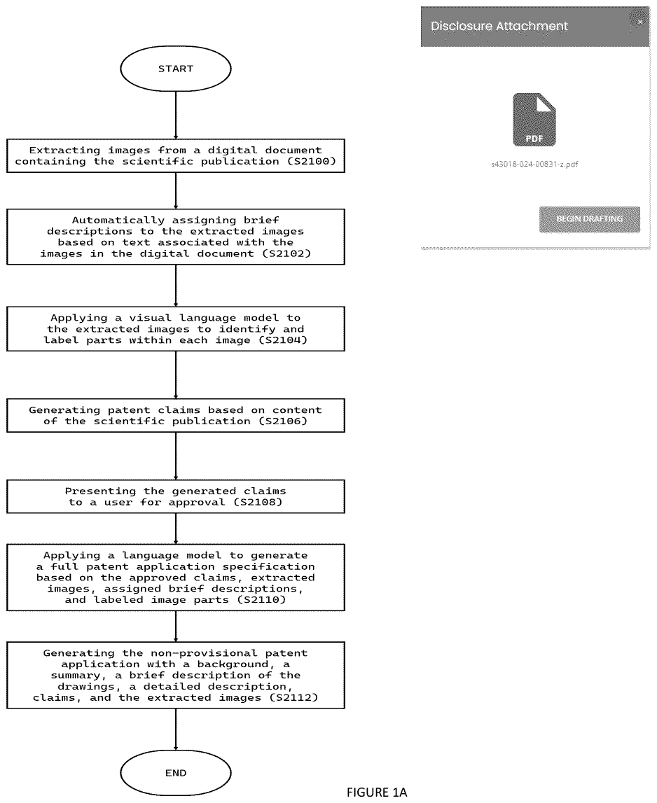

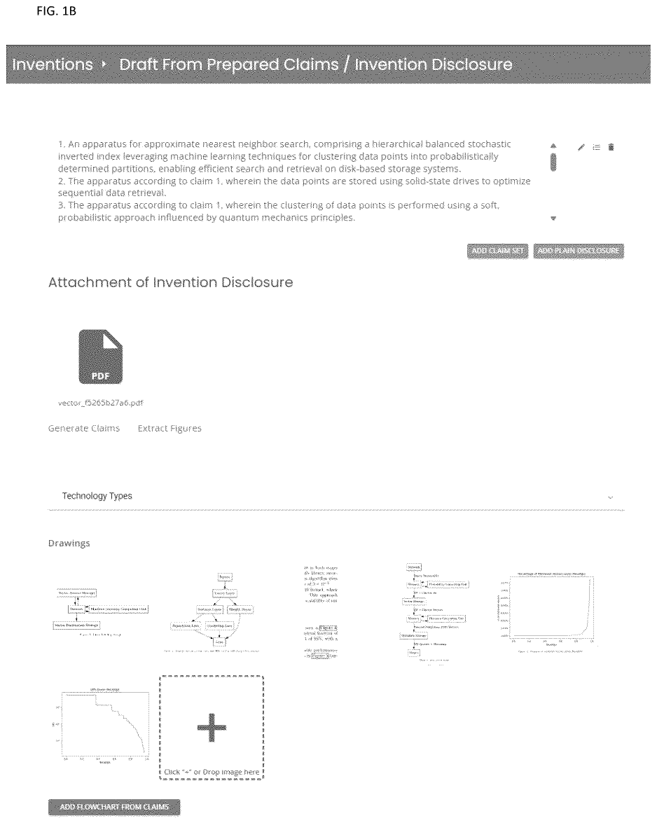

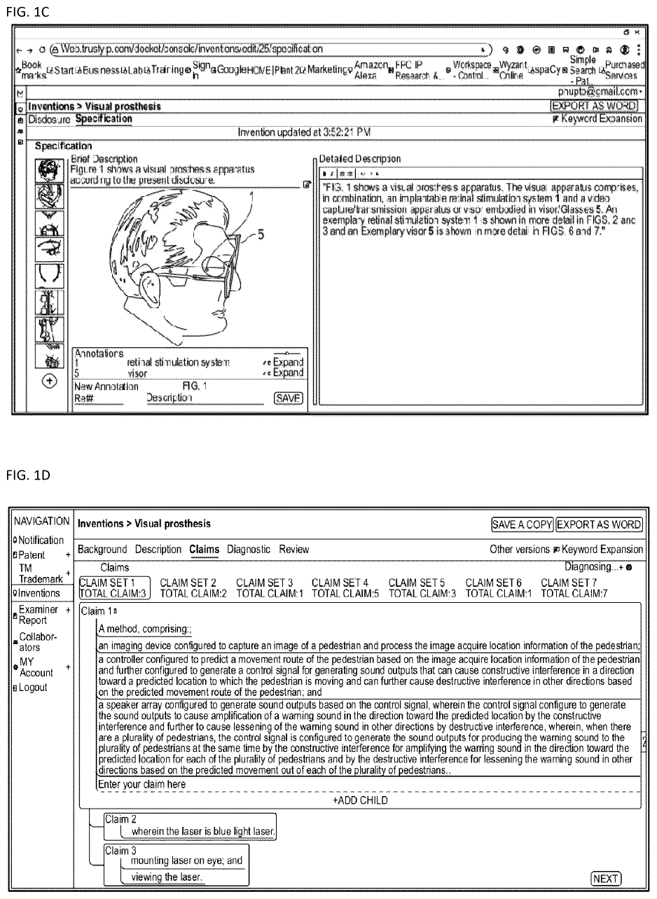

### DETAILED DESCRIPTION OF THE INVENTION

One implementation provides a method whereby images are extracted from a digital document embodying a scientific publication (reference label S2100). This extraction process serves as a cornerstone for preparing patent documentation by utilizing the extracted drawings to shape the claims and specifications of a patent application. The images are generated by the inventors to illustrate their inventions, and are interwoven with textual descriptions, reinforce the narrative of one implementation to aid in comprehending the nuances of the concept. By incorporating these extracted images into patent applications, one implementation ensures that the visual aids are not only accurate representations of the disclosure but are also tailored to satisfy regulatory criteria for patent illustrations.

The process begins with the provision of a scientific publication or digital document that delineates various concepts, embodiments, or technological advancements suitable for patent protection. Once the document is obtained, images contained within the document are extracted. Each image, which may depict a component, apparatus, flowchart, or any other illustration pertinent to one implementation, undergoes analysis by a visual language model. In one implementation, the document is a PDF file or a Latex file. Text and images are extracted using a multimodal large language model that handles text and images. One implementation relates to automated systems and methods for enhancing efficiency in patent-related work processes. Specifically, reference label S2102 pertains to an automated mechanism that assigns brief descriptions to images that have been extracted from the scientific publication or. The system it analyzes the text associated with each image within the document to determine the most relevant and concise description. This function ensures that the images are appropriately contextualized with respect to their associated descriptive text, facilitating their incorporation into patent applications. The brief descriptions of the drawings are generated for user review, relying on algorithms that can interpret and summarize the content adjacent to the images, which might include figure legends, in-text references, or other indicative textual segments. By implementing this automated feature, the implementation substantially reduces the duration and effort required by patent professionals to draft applications, ensuring that the images are accurately depicted and correspondingly described, thereby streamlining the patent drafting process.

The LLM is used for generating patent claims (S2106) based on the content found within a scientific publication. This function extracts valuable conceptual material from the publication and using it as a foundation to construct claims that capture the essence and novelty of the prospective one implementation. Once generated, these claims undergo a user validation process to ensure they accurately reflect the applicant's intentions and are correctly aligned with patentable subject matter. This step effectively bridges the gap between the innovative concepts detailed in scientific literature and the formal requirements of patent drafting, contributing to a thorough patent application that can withstand the scrutiny of patent examination.

In one embodiment of one implementation, a method is disclosed wherein the step of presenting the generated claims to a user for approval (S2108) is part of the process. This step encompasses the operation of displaying the synthesized patent claims to an individual, typically a patent practitioner, inventor, or a designated stakeholder, for the purpose of obtaining their revision/approval of the claims' content and structure. The generated claims are sourced from the thematic elements identified in a scientific publication and are a product of predetermined algorithms and language models. The user's validation is a juncture in the process, as it ensures that the presented claims are accurate, legally sound, and ready to be integrated into the full patent application. The validation acts as a checkpoint to guarantee that the claims align with the intended scope of protection and manifest the aspects of one implementation, thereby providing the foundation for a and defensible patent application. Upon receipt of approval from the user, the method advances to subsequent steps, including the integration of these validated claims into a comprehensive patent application effectively tailored to meet the requirements of patentability.

Reference label S2110 pertains to a phase in the operation of the disclosed computer-based system, where the pre-approved patent claims, extracted images, and their associated brief descriptions, along with the labeled components, are subjected to the processing capabilities of a language model. The function of this language model is to synthesize and integrate these individual elements into a cohesive patent application specification. This integration results in the creation of a unified document that links the approved claims to their visual representations and descriptive texts, thereby streamlining the documentation process and enhancing the clarity and precision of the patent application details. Such a specification serves as the foundation for the subsequently generated non-provisional patent application, encompassing the background of one implementation, the summary of one implementation, a detailed description that elaborates on the technicalities and nuances of one implementation, and the full set of claims that delineate the scope of the patent protection sought. Notably, the application prepared by this method aligns with the conventions and standards prescribed by the United States Patent and Trademark Office (USPTO) or other offices such as the EPO, CIP, JPO and KPO, among others, ensuring that the generated content meets the requisite legal and technical thresholds for patentability.

As part of patent drafting, claims are crafted to capture the features of one implementation. These claims are grounded in the visual representations embodied in the images. Through the inclusion of bounding boxes, the nexus between the claims and their corresponding visual depictions is strengthened. It allows the claims to incorporate by reference the parts identified in the images, providing a well-defined specification in the patent application. In the detailed description of the present embodiment, a method and system for enhancing patent application drafting by employing computer-aided techniques are presented. Specifically, the method involves generating bounding boxes around identified parts within each image. Using image recognition algorithms, the visual language model identifies distinct parts within each extracted image and labels these parts accordingly. These parts are recognized by their shapes, patterns, and context within the image, which are then compared to known data structures and labeling conventions. Following the identification and labeling process, bounding boxes are generated around the identified parts within each image. Bounding boxes serve as visual markers that denote the boundary and position of each part. These bounding boxes simplify the visual analysis for users, such as inventors or patent practitioners, by clearly demarcating how various components relate spatially and functionally within one implementation. Calibrated algorithms are fine-tuned to adapt to the varying complexities and intricacies present within different types of images. This attention to detail ensures that the bounding boxes encapsulate each identified part without overlaps or exclusions that might lead to ambiguity.

The finalized patent application, embodying the claims, detailed descriptions, and the extracted images with generated bounding boxes, is then assembled. This package provides a comprehensive disclosure of one implementation that not only complies with the requirements set by the United States Patent and Trademark Office (USPTO) but also furnishes support for the claims in anticipation of examination and any subsequent legal scrutiny. The process, therefore, not only facilitates the drafting of a patent application but also fortifies the application against potential challenges by clearly delineating the innovation through combined textual and visual representations.

In searching the database, the method involves a strategic examination of historical patent application data to uncover a subset of prior patent applications that not only reside within the identical technology field as the subject patent application but also share a commonality in referencing the very same prior art documents. This identification process is pivotal for formulating an effective response to the office action, as it provides insights into relevant examiner expectations and previously successful strategies for overcoming rejections pertinent to this technical domain.

Most scientific publication start with a prior work section. Incorporating a prior work discussion into a patent application involves analyzing existing literature and patentability search results to identify relevant prior art that may be pertinent to one implementation. The background section is typically used to discuss the state of the art, including any problems that exist which the current one implementation seeks to overcome.

In this context, the prior work discussion for EPO applications may be presented in a narrative that justifies the need for one implementation, highlights its improvements over the prior art, and sets the stage for a clear understanding of the concepts, without partitioning the text into distinct sections. This approach ensures that the detailed description is a cohesive, continuous disclosure that describes one implementation in full, technical detail while acknowledging the prior art and substantiating the innovative leap made by the current one implementation.

In another implementation, a method for generating an application includes receiving a user paper; generating one or more claims from the user paper; automatically extracting one or more figures from the paper using a large language model (LLM); extracting a part list from each figure using the LLM and generating a set of reference signs for the figure; and applying the LLM to generate the application.

```
llm = LLM(model_name=“gpt-5”) # Assuming use of GPT-5 but can be Llama, Mistral, Bloom, LaMDA,
PaLM, GATO, MT-NLG, Alpaca, FLAN UL, Claude, etc.
def receive_user_paper(file_path):
  loader = PDFLoader(file_path)
  documents = loader.load( )
  return documents
def generate_claims(paper_content):
  claim_prompt = PromptTemplate(
    input_variables=[“paper_content”],
    template=“Based on the following research paper, generate patent claims:\n\n{paper_content}”
  )
  claim_chain = LLMChain(llm=llm, prompt=claim_prompt)
  claims = claim_chain.run(paper_content=paper_content)
  return claims
def extract_figures(paper_path):
  figures = [ ]
  # Use a PDF library to extract images from the PDF such as PyMuPDF (fitz) library
  return figures
def extract_part_list_and_generate_reference_signs(figure):
  # Convert figure to text using OCR
  text = pytesseract.image_to_string(Image.open(figure))
    part_list_prompt = PromptTemplate(
    input_variables=[“figure_text”],
    template=“Extract a list of parts from this figure description and generate reference
signs:\n\n{figure_text}”
  )
  part_list_chain = LLMChain(llm=llm, prompt=part_list_prompt)
  part_list_and_signs = part_list_chain.run(figure_text=text)
  return part_list_and_signs
def generate_application(paper_content, claims, figures, part_lists):
  application_prompt = PromptTemplate(
    input_variables=[“paper_content”, “claims”, “figures”, “part_lists”],
    template=“Generate a patent application based on this research paper, claims, figures, and part
lists:\n\nPaper: {paper_content}\n\nClaims: {claims}\n\nFigures: {figures}\n\nPart Lists: {part_lists}”
  )
  application_chain = LLMChain(llm=llm, prompt=application_prompt)
  application = application_chain.run(
    paper_content=paper_content,
    claims=claims,
    figures=figures,
    part_lists=part_lists
  )
  return application
def main(paper_path):
  # Receive user paper
  paper = receive_user_paper(paper_path)
  paper_content = “ ”.join([doc.page_content for doc in paper])
  # Generate claims
  claims = generate_claims(paper_content)
  # Extract figures
  figures = extract_figures(paper_path)
  # Extract part lists and generate reference signs
  part_lists = [ ]
  for figure in figures:
    part_list = extract_part_list_and_generate_reference_signs(figure)
    part_lists.append(part_list)
  # Generate application
  application = generate_application(paper_content, claims, figures, part_lists)
```

In brief: receive_user_paper: Uses LangChain's PDFLoader to load the user's paper; generate_claims: Uses the LLM to generate patent claims based on the paper's content.; extract_figures: This is a placeholder function using a library PyMuPDF; extract_part_list_and_generate_reference_signs: Uses OCR (via pytesseract) to extract text from figures, then uses the LLM to generate a part list and reference signs; generate_application: Uses the LLM to generate the full patent application based on all the gathered information.

In the detailed description of the embodiment, new aspects discovered within the scientific publication are structured into a stratified set of claims, of which independent claims articulate the broad concepts, and dependent claims further refine or limit these concepts based on specific features or embodiments. The comprehensive evaluation and structuring of these aspects ensure that the independent claims effectively delineate one implementation's scope without impinging upon the prior art. This approach to claim structuring leverages the sequential relationship between independent and dependent claims, wherein each dependent claim incrementally narrows the scope of the claim it references by adding additional limitations.

These limitations, extracted from the detailed exploration of the aspects, enhance the clarity, enforceability, and potential patentability of one implementation. For example, if one implementation relates to a medical device, an independent claim may describe the device in broad terms, specifying components for its functionality, while a dependent claim may detail particular materials or manufacturing techniques that provide specific benefits such as increased durability or biocompatibility. In instances where one implementation pertains to a process or method, an independent claim may outline the steps required to achieve the desired outcome in their most general form, whereas dependent claims would provide for variations in these steps or additional steps that contribute to efficiency, effectiveness, or applicability under various conditions.

The detailed description might include, without limitation:
A comprehensive explanation of one implementation's technical field and the background that contextualizes the improvements one implementation offers over the prior art.
An in-depth analysis of the components, structure, or steps of the method of one implementation, showing with clear support why these features are and non-obvious.
A delineation of various embodiments of one implementation, potentially reflecting the language and concepts of the allowed claims from the identified prior patent applications. If the original application covers a broad aspect, narrower embodiments that specifically address the examiner's concerns might be detailed.

In accordance with one aspect of the embodiment, a method is introduced for preprocessing a digital document to extract text and metadata associated with a scientific publication. The preprocessing includes the removal of extraneous formatting and the isolation of meaningful content such as the title, authors, affiliations, abstract, main body of text, and references. The extracted textual content and metadata are fundamental for performing subsequent steps in the development of a patent application, as they offer a streamlined and focused compilation of the scientific publication's content.

The extracted text is processed to discern and standardize terminologies, which not only ensures consistency throughout the patent application but also aligns with the terminologies employed in the relevant field of one implementation. This process benefits the drafting of the claims section and supports the clear articulation of the technical aspects within the detailed description. The metadata, which may include publication date, identifiers such as DOI, and other bibliographic details, is instrumental in establishing the novelty and non-obviousness of the claimed one implementation.

The preprocessing further incorporates the identification and extraction of any graphical elements such as figures, tables, and diagrams from the digital document. These graphical elements are then subjected to an additional layer of analysis to understand their significance and how they interconnect with the textual content.

Once the text and metadata are extracted, the method advances by converting the raw text into a format amenable for assessment by a patent practitioner or a language model which aids in the construction of a patent application. This format conversion implies a restructuring of the text to fit the conventional sections of a patent application, such as the background of one implementation, summary, and detailed description.

Subsequent to the extraction and conversion, the text and metadata form the basis for drafting the detailed description of one implementation. The detailed description elucidates the scope and execution of one implementation, providing a comprehensive explanation that allows one of ordinary skill in the art to practice one implementation without undue experimentation. It methodically presents the underlying principles, functional embodiments, and possible variations of one implementation, all derived from the extracted content of the scientific publication.

This detailed description may reference the previously identified graphical elements, aligning with the text to clarify and exemplify embodiments of one implementation. Each graphical element is accompanied by a figure description that explicitly labels and explains its components and their interaction. The descriptive text interweaves the technical information extracted from the publication with the patent principles to articulate the aspects of one implementation, its advantages, and its applicability within its field. Utilizing the preprocessed text and metadata as a foundation ensures that the narrative of one implementation is cogently depicted and legally coherent, paving the way for the generation of patent claims that adequately capture the scope of one implementation.

Once the image objects are accurately identified, the method ensures that each of these objects is saved as separate image files. The process of saving involves creating distinct files for each of the identified image objects, thereby isolating them from the text and other content present in the digital document. This isolation is for ensuring that the images can be individually addressed, annotated, or manipulated, if necessary, without affecting the integrity of the original document.

The separate image files serve as standalone visual aids that can be comprehensively referenced or incorporated into the patent application. They provide clear and discernible representations that are vital for thoroughly conveying the aspects and embodiments to those skilled in the art. By presenting the image objects independently, the patent application can effectively detail the components, configurations, and operational functionalities that form the crux of one implementation.

Furthermore, these extracted image files are prepared for subsequent steps wherein they may undergo various enhancements or modifications such as labeling, annotating with brief descriptions, or any other alterations necessary to comply with the patent submission standards. The saved image files facilitate a more granular level of detail that may be required to illustrate specific points or features within the broader scope of the detailed description. The end goal of this extraction process is to create a and informative patent application that provides a clear understanding of one implementation through complementary text and visual depography.

Automatically assigning brief descriptions to the extracted images involves analyzing the digital document to locate figure captions or text that is spatially proximate to each image. This process typically includes parsing the digital content to detect typographical features that differentiate captions or descriptive text from the main body content. Upon locating these captions or nearby text, such text is then extracted and used as the basis for generating brief descriptions that succinctly summarize the subject matter, context, or salient features of the associated images.

In the context of a detailed description for a USPTO patent application, the content related to automatically assigning brief descriptions would be incorporated into the narrative without introductory phrases, headers, or any special text formatting. The detailed description would flow continuously and include descriptions of all images, wherein the description for each image would follow seamlessly after discussing relevant aspects of one implementation. The language used would be descriptive and to ensure a clear understanding of one implementation by those skilled in the art.

For example, if a digital document contains an image of a device, the detailed description might read:

An image shows a perspective view of the device, in which the primary housing, depicted at the upper portion, contains the central processing unit and memory storage. The display interface located on the front side presents output to the user and receives touch input, as indicated by the symbols surrounding the display perimeter. Adjacent to the display interface and within the lower section of the device is the input-output control section, which is detailed clearly by the figure caption stating “Front view of the device showcasing the input-output control section with the main buttons and their respective functions listed.”

Continuing, another image in the sequence reveals a cutaway view, providing insight into the internal arrangement of components. Here, the complex layered structure of the circuit board and the interconnects between different modules can be seen. The caption neatly summarizes this perspective, declaring, “Cutaway view illustrating the internal layering of the device's circuit board.”

The descriptions are built directly from the captions and nearby text extracted from the digital document, thus maintaining the essence of the original material while suitably adapting it for the more formal context of a patent application. This narrative ensures that each element in the figures is properly introduced and described in relation to one implementation, leaving no ambiguity about the construction and function of the device as embodied in the images.

Applying the visual language model involves the utilization of an computer vision model that has been trained to recognize and annotate various components within technical drawings and diagrams. This model is imbued with the capability to discern even the most intricate details contained within these visual representations. Upon the introduction of each extracted image into the model's interface, it commences a thorough analysis. During this process, the model scrutinizes the images, seeking to identify all constituent parts showcased within.

In the realm of technical diagrams, where precision is paramount, the model diligently labels each identified part. These parts can range from the elementary, such as basic geometric shapes defining a component's boundaries, to the complex, featuring intricate assemblies and sub-assemblies that are used to conveying the functional narrative of one implementation. The labels assigned by the model serve not only as identifiers for the parts but also as a means of classification, ensuring that each component can be easily referenced and understood in the context of the wider one implementation.

The model's ability to recognize and label parts is not a rudimentary process; it signifies the culmination of extensive training on a vast array of technical drawings and diagrams. The machine learning algorithms at its have been exposed to, and have learned from, a diverse collection of annotations that epitomize industry standards. Consequently, the model's output adheres to these standards, providing labels that are both descriptive and exact, facilitating a clear understanding of one implementation's components and their respective functions.

Moreover, this rigorous labeling process presents an invaluable tool for the creation of a detailed patent description. By incorporating the model's results, a comprehensive depiction of one implementation is constructed, highlighting the individual parts, their relationships, and cooperative functions. These identified and labeled parts form the foundation upon which the detailed description is elaborated, methodically painting a picture of one implementation in prose form that is both technically accurate and legally precise.

In generating patent claims, a language model is employed to analyze the text of the scientific publication, effectively pinpointing the aspects that were heretofore undisclosed in the field of art concerned. These aspects, once identified, form the crux upon which new patent claims are crafted, ensuring the alignment of the claims with the original innovative contributions presented in the publication.

The detailed description of one implementation delineates the technical nuances for comprehending the scope and implementation of the aspects that have been transformed into patent claims. It expounds on the nature and operation of one implementation, providing a clear, enabling disclosure that allows a person skilled in the art to not only understand one implementation but also to practice it without undue experimentation.

To begin with, the detailed description elucidates the underlying principles of one implementation, often rooted in the innovative concepts presented in the scientific publication. It then transitions into a granular explanation of the embodiments of one implementation, using the aspects as a foundation for in-depth elucidation. Each embodiment is detailed not merely in isolation but typically in the context of how it contributes to and interacts with the overarching concept.

This description further ventures into detailed operational states of one implementation, offering an insight into the various configurations and conditions under which one implementation can perform optimally. It often includes a thorough discussion of its functionality, providing tangible examples and experimental data as warranted, which are instrumental in validating the efficacy of one implementation as claimed.

Additionally, the detailed description delineates the constituent elements of the embodiments, their interconnections, and interdependencies, often depicting how these elements collaborate to fulfill the objectives of one implementation. To reinforce the understanding of these elements and their cooperative function, the description may also juxtapose certain embodiments, highlighting their distinctive features, advantages, and potential variations.

Manifest within the embodiment description is the provision for encompassing variations, modifications, and alternative structures. These are thoughtfully acknowledged and described to ensure the detailed description sufficiently covers the breadth of one implementation, thus fulfilling the patent law requirements regarding full disclosure.

Encapsulating the various embodiments and operational nuances, the detailed description culminates in a depiction of how each claim element is embodied within one implementation. This segment bridges the aspects of one implementation with the legal constructs of the claims, cementing the relationship between the disclosed embodiments and the scope of patent protection sought.

This comprehensive narrative, devoid of chapter-wise separation or textual compartmentalization, constitutes the of the detailed description. It fosters an instructive roadmap that guides a person skilled in the relevant art through the intricacies of one implementation, elucidating its construction, utility, and the novelty it introduces to its field of endeavor.

One implementation relates to presenting generated claims by displaying the claims in an editable user interface. The user interface is configured to enable the user to conveniently modify, add, or delete claims as per requirements.

In a detailed description consistent with the U.S. Patent and Trademark Office standard, the claims that are generated are reflective of innovative aspects that one implementation discodes and seeks to protect. The editable user interface allows alterations to be made directly to the text of the claims, supporting the iterative process of honing the language to capture the scope of the patented subject matter. Users are presented with the automated output of generated claims, and the interface is designed to facilitate immediate and intuitive modification.

While reviewing the displayed claims, a user may determine that additional specificity is required to distinguish the claimed one implementation from prior art, or that broader language may be appropriate to adequately cover the potential embodiments of one implementation. This claim modification process is a task in drafting a patent application, as the claims define the legal boundaries of patent protection.

Furthermore, users have the capability to supplement the claim set with dependent claims that further refine and elaborate upon the elements of the independent claims. Dependent claims typically incorporate all the features of the claim to which they refer and add further limitations. This can be for defending the validity of a patent during litigation or prosecution as it provides fallback positions.

The deletions of claims, on the other hand, allow users to streamline the application by removing superfluous or potentially overlapping claims that could complicate the examination process. Limiting the number of claims can also serve to focus the examination on the most aspects of one implementation and can be a cost-saving measure considering the fees associated with excess claims.

The detailed description, as it pertains to these presented claims, would provide a full disclosure of one implementation in such full, clear, concise, and exact terms to enable any person skilled in the art to which it pertains, or with which it is most nearly connected, to make and use the same. This includes a description of the process, machine, manufacture, composition of matter, or improvement invented, and must set forth the best mode contemplated by the inventor or joint inventor of carrying out one implementation.

The detailed description would elaborate on the relationship between the presented claims and the technical aspects of one implementation, illustrating, for example, how a claimed processor might be configured to perform certain operations, or how a claimed chemical composition achieves a desired effect. The detail provided ensures that the essence of one implementation is disclosed in such a way that it supports the scope of the submitted claims and provides a clear narrative as to one implementation's groundbreaking nature and functionality.

This description does not, typically, include an introductory preamble, headings, or text formatting indicative of document structure such as found in markdown or similar stylistic formatting protocols. It is a purely technical narrative crafted to satisfy legal requirements and facilitate understanding by experts in the field.

In the process of applying the language model to generate a full patent application specification, the creation of a Background section plays a pivotal role. This section typically establishes the context and rationale for one implementation as well as its relevance within the field. To achieve this, the language model employs strategies to extract meaningful and pertinent introductory text from the scientific publication that sparked one implementation, carefully avoiding the inclusion of boilerplate language or overly broad statements that might detract from the aspects of one implementation.

By extracting concepts, technical insights, and the problem statement directly from the source material, the model ensures that the Background section aligns with the overall narrative of the scientific advancement being patented. This outlines not only the prior art but also the shortcomings and limitations that exist within the current state of technology, thereby underscoring the necessity for one implementation.

Adhering to the USPTO patent standard, which calls for a clear, concise, and exact description of one implementation and its applicability, the Background section developed through the language model uses a focused and relevant exposition to set the stage for the Detailed Description that follows. This Detailed Description delves into the technical intricacies of one implementation, expounding upon the innovative features and embodiments without introductory remarks, headings, or distinct sections delineated by text formatting. Instead, it maintains a continuous narrative flow that expertly intertwines explanations of one implementation's components, its method of operation, and the specific technical problem it addresses.

The content drawn from the scientific publication is expanded upon to illustrate the various aspects of one implementation, ensuring a logical progression from the broader context laid out in the Background to the specificities detailed in the subsequent sections. Through the synthesizing of complex scientific material, the Detailed Description aims to provide the reader, most notably the patent examiner, with a thorough understanding of one implementation, its construction, and deployment, all while adhering to patent drafting conventions that omit superfluous embellishments such as formatting and non-headings.

Beginning with the first embodiment of one implementation, the detailed description discloses an innovative arrangement as depicted in the extracted images. The images serve to elucidate the physical nature of the components involved, their spatial and functional interrelationships, and the aesthetic considerations, if any. Each component as labeled in the images carries a specific designation pointed out by annotated parts, which are referenced hereinafter by their previously assigned brief descriptions.

For instance, image part 202 may illustrate a coupling mechanism that allows two or more separate elements to be joined together in a reversible manner. The coupling mechanism is detailed showing the parts, such as interlocking tabs and corresponding slots, highlighting how they interact to provide stability and ease of assembly. The descriptions and labels from the images interweave with the textual explanation to enable clear and complete understanding.

The embodiment proceeds to describe processes and methods embodied in one implementation, integrating the described components into a system or assembly. The narrative delineates the sequence of operations and identifies potential alternative configurations. For example, if one implementation encompasses a method of using the coupling mechanism, the text describes the actions taken by a user to engage and disengage the components, supported by references to the images where these actions are graphically represented.

Furthermore, the detailed description reveals variations under the principal embodiment. These variations may address different use cases, adaptations for various environments, or alternative designs accomplishing the same purpose. Such variations may be detailed with additional extracted images, each accompanied by their respective brief descriptions and labeled image parts. This inclusive detailing ensures that a person skilled in the art could appreciate the scope and scale of variations without departing from the principles of one implementation.

As part of the lifecycle, patent applications are examined and are commonly rejected. The system applies AI to draft responses for the user to respond to rejections or office actions. Then, the system applies AI to identify licensing candidates based on their current/announced future product's proximity to the claims; and to run a CRM to optimize the licensing campaign.

After having received an office action from a patent examiner and identified rejections therein, the process of constructing a detailed response with the LLM involves several stages. Among these, one aspect is to consider the historical tendencies of the examiner who has issued the rejection. To this end, a proactive approach that includes analyzing appeal statistics from the prosecution history data is undertaken. A scan through the available prosecution history is done to ascertain the percentage of rejections the examiner has sustained, as well as those overruled upon further review. Attention is paid to any discernible patterns that could suggest a proclivity towards certain types of arguments or evidential support. Furthermore, it is notable that appeal outcomes can also influence the language and tone of the response, as well as the decision whether to argue aggressively or attempt a more moderate claim amendment. This analysis is not a mere statistical exercise; it provides a strategic vantage point from which a more tailored and informed response can be crafted.

The system provides a browser based claim editing system. Creating a browser-based user interface for modifying, adding, moving, or deleting patent claims while managing independent and dependent claims and highlighting antecedent basis errors and 112 support issues is a complex undertaking. The hierarchical structure of patent claims, with their intricate dependency relationships, poses significant challenges for implementing intuitive editing functionality and automatic claim renumbering. Real-time analysis of antecedent basis and 112 support requires natural language processing and computationally intensive operations, which can affect browser performance. Ensuring cross-browser compatibility for text editing and rendering complex claim structures adds another layer of difficulty. Moreover, maintaining data integrity during editing, implementing robust undo/redo functionality, and designing an interface that balances simplicity with the necessary tools for patent claim manipulation are all formidable tasks.

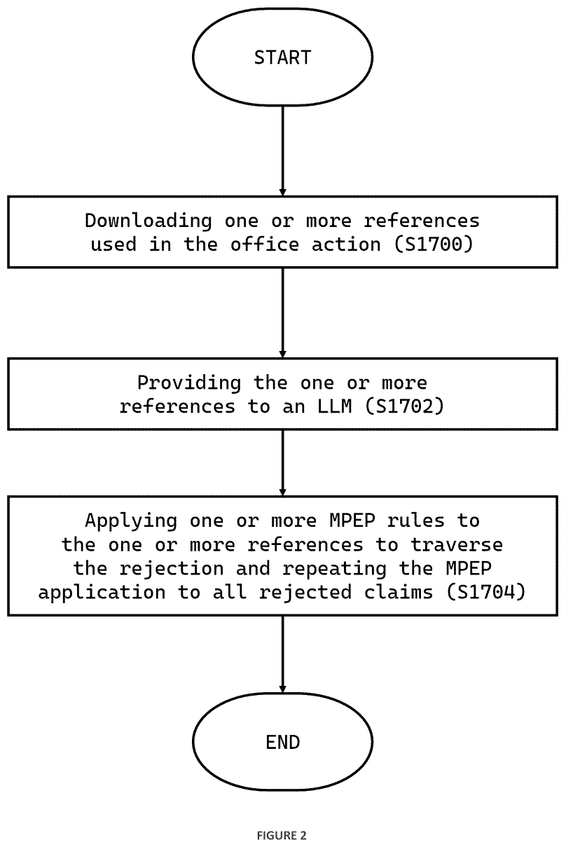

FIG. 2 illustrates the process of downloading references, providing them to a large language model (LLM), and applying MPEP rules or EPO rules of patentability to each rejection.

The operation “downloading one or more references used in the office action S1700” signifies the initial step where the system retrieves references cited in the office action. This process involves accessing or downloading specific documents or data that the patent examiner has used to support rejections or objections in order to analyze them further.

In this step of the process, identified as S1702, the one or more references that have been downloaded as part of an office action are subsequently provided to a large language model (LLM). The language model is utilized to process and analyze these references, aiding in formulating responses to the rejections cited in the office action. The provision of these references to the LLM is a part of leveraging artificial intelligence in examining and responding to the cited materials effectively.

The method includes applying one or more patent examination rules to the one or more references to traverse the rejection and repeating the rule application to all rejected claims is done at S1704. This step involves using various rules from the Manual of Patent Examining Procedure addressing 112, 101, 102 and 103 rejections found in a patent application (or patentable under Articles 52 to 57, which include novelty and inventive step; (b) the subject-matter of the patent is insufficiently disclosed; and (c) that the patent contains added subject-matter in the EPO). By doing so, each applicable reference is methodically evaluated to counter the rejection, ensuring that all rejected claims are considered thoroughly in this process.

In one exemplary code for analyzing office actions and generating responses:

```
  def analyze_examiner_and_construct_response(office_action, examiner_id):
    # Analyze examiner statistics
    examiner_stats = get_examiner_statistics(examiner_id)
      allowance_rate = examiner_stats[‘allowance_rate’]
    sustained_rejection_rate = examiner_stats[‘sustained_rejection_rate’]
    appeal_success_rate = examiner_stats[‘appeal_success_rate’]
    interview_success_rate = examiner_stats[‘interview_success_rate’]
    # Analyze rejections in current office action
    rejections = parse_rejections(office_action)
    response_strategy = determine_response_strategy(allowance_rate, sustained_rejection_rate,
appeal_success_rate)
    # Search for prior successful arguments
    for rejection in rejections:
      prior_art_references = rejection[‘cited_references']
      successful_arguments = search_successful_arguments(prior_art_references)
          if successful_arguments:
        adapt_prior_arguments(rejection, successful_arguments)
      else:
        craft_new_argument(rejection, response_strategy)
    # Determine if interview would be beneficial
    if interview_success_rate > INTERVIEW_THRESHOLD:
      schedule_examiner_interview( )
    # Search for patented cases with similar rejections using same prior art reference(s)
    similar_patented_cases = find_similar_patented_cases(rejections)
    winning_arguments = extract_winning_arguments(similar_patented_cases)
      # Construct response
    response = construct_response(rejections, response_strategy, winning_arguments)
    if appeal_success_rate > APPEAL_THRESHOLD and response_strategy == ‘aggressive’:
      prepare_appeal_brief( )
      return response
  Def determine_response_strategy(allowance_rate, sustained_rejection_rate,
appeal_success_rate):
    if allowance_rate > HIGH_ALLOWANCE_THRESHOLD:
      return ‘assertive’
    elif sustained_rejection_rate > HIGH_SUSTAINED_REJECTION_THRESHOLD:
      return ‘moderate’
    elif appeal_success_rate > HIGH_APPEAL_SUCCESS_THRESHOLD:
      return ‘aggressive’
    else:
      return ‘balanced’
  def search_successful_arguments(prior_art_references):
    # Search database for cases where the same references were successfully overcome
    # Return any relevant arguments
    pass
  def adapt_prior_arguments(rejection, successful_arguments):
    # Modify successful arguments to fit current rejection
    pass
  def craft_new_argument(rejection, response_strategy):
    # Create new argument based on rejection and chosen strategy
    pass
  def find_similar_patented_cases(rejections):
    # Search for patented cases with similar rejections
    pass
  def extract_winning_arguments(similar_patented_cases):
    # Analyze and extract successful arguments from similar patented cases
    pass
  def construct_response(rejections, response_strategy, winning_arguments):
    # Build final response incorporating all gathered information and arguments
    pass
  def process_office_action(office_action, patent_office):
    llm = initialize_large_language_model( )
    rejections, prior_art = analyze_office_action(llm, office_action, patent_office)
    examiner = extract_examiner_info(office_action)
    examiner_history = query_examiner_history(examiner)
    similar_cases = find_similar_cases(rejections, prior_art, patent_office)
    successful_arguments = analyze_successful_arguments(llm, similar_cases, patent_office)
    response = generate_response(llm, rejections, successful_arguments, patent_office)
    output_response(response)
  # Function to analyze office action using LLM with specific rejection types
  def analyze_office_action(llm, office_action, patent_office):
    if patent_office == “USPTO”:
      Analyze the following USPTO office action and identify each and every basis to traverse
rejections:
      1. 35 U.S.C. 112 rejections (written description, enablement, indefiniteness)
      2. 35 U.S.C. 101 rejections (subject matter eligibility)
      3. 35 U.S.C. 102 rejections (novelty)
      4. 35 U.S.C. 103 rejections (obviousness)
      Also identify all cited prior art references.
    elif patent_office == “EPO”:
```

Analyze the following EPO office action and identify each and every basis to traverse rejections:

```
      1. Article 52 EPC (patentable inventions)
      2. Article 54 EPC (novelty)
      3. Article 56 EPC (inventive step)
      4. Article 83 EPC (sufficiency of disclosure)
      5. Article 123(2) EPC (added subject matter)
      Also identify all cited prior art references.
      Office action: {office_action}
    analysis = llm.generate(prompt)
    rejections = extract_rejections(analysis, patent_office)
    prior_art = extract_prior_art(analysis)
    return rejections, prior_art
  # Function to extract specific rejections based on patent office
  def extract_rejections(analysis, patent_office):
    if patent_office == “USPTO”:
      rejection_types = {
        “112”: extract_112_rejections(analysis),
        “101”: extract_101_rejections(analysis),
        “102”: extract_102_rejections(analysis),
        “103”: extract_103_rejections(analysis)
      }
    elif patent_office == “EPO”:
      rejection_types = {
        “52”: extract_52_rejections(analysis),
        “54”: extract_54_rejections(analysis),
        “56”: extract_56_rejections(analysis),
        “83”: extract_83_rejections(analysis),
        “123”: extract_123_rejections(analysis)
      }
    return rejection_types
  # Functions to extract specific rejection types (example for USPTO)
  def extract_112_rejections(analysis):
    # Extract written description, enablement, and indefiniteness rejections
    pass
  def extract_101_rejections(analysis):
    # Extract subject matter eligibility rejections
    Discuss factors that overcome Alice such as computer performance enhancement, etc.
  pass
  def extract_102_rejections(analysis):
    # Extract novelty rejections
    Discuss why each reference fails to show claim language (original or amended)
    pass
  def extract_103_rejections(analysis):
    # Extract obviousness rejections
    Discuss every factors such as inoperability of combination and others per MPEP 2141-2144
    pass
  # Similar functions would be implemented for EPO rejections
  # Function to find similar cases in database
  def find_similar_cases(rejections, prior_art, patent_office):
    rejection_types = “ OR ”.join(rejections.keys( ))
    SELECT * FROM patent_applications
    WHERE patent_office = ‘{patent_office}’
    AND ({rejection_types})
    AND prior_art SIMILAR TO ‘{prior_art}’
    AND status = ‘granted’
      return database.execute(query)
  # Function to analyze successful arguments using LLM
  def analyze_successful_arguments(llm, similar_cases, patent_office):
    Analyze the following successful arguments from similar {patent_office} cases:
    {similar_cases}
    Summarize key strategies for overcoming each type of rejection:
    {“112, 101, 102, and 103” if patent_office == “USPTO” else “52, 54, 56, 83, and 123”}
    return llm.generate(prompt)
  # Function to generate response using LLM
  def generate_response(llm, rejections, successful_arguments, patent_office):
    Generate a response to the following {patent_office} office action rejections:
    {rejections}
    Use prior successful arguments as a guide:
    {successful_arguments}
    Ensure the response is tailored to the specific rejections in the current office action,
    For each claim, addressing each rejection type separately and comprehensively in accordance
with national evaluation standards/rules. For USPTO responses, cite relevant MPEP sections. For EPO
responses, cite relevant EPC articles and guidelines.
  return llm.generate(prompt)
  # Main execution
    patent_office = input(“Enter the patent office (USPTO or EPO or JPO or CIPO ....): ”)
    process_office_action(for each claim, apply examination rule for patent_office)
  # end Main
```

The pseudocode address specifics of rejection types (e.g., 112 written description, enablement, indefiniteness for USPTO; Articles 52, 54, 56, 83, 123 for EPO) with tailored prompts for the LLM to analyze office actions and generate responses based on the specific patent office and rejection types. This approach allows for a more comprehensive and jurisdiction-specific analysis of patent office actions, enabling the system to generate more accurate and tailored responses. The LLM is guided to consider the specific rules and guidelines of each patent office, ensuring that the generated responses are relevant and potentially more effective in addressing the rejections.

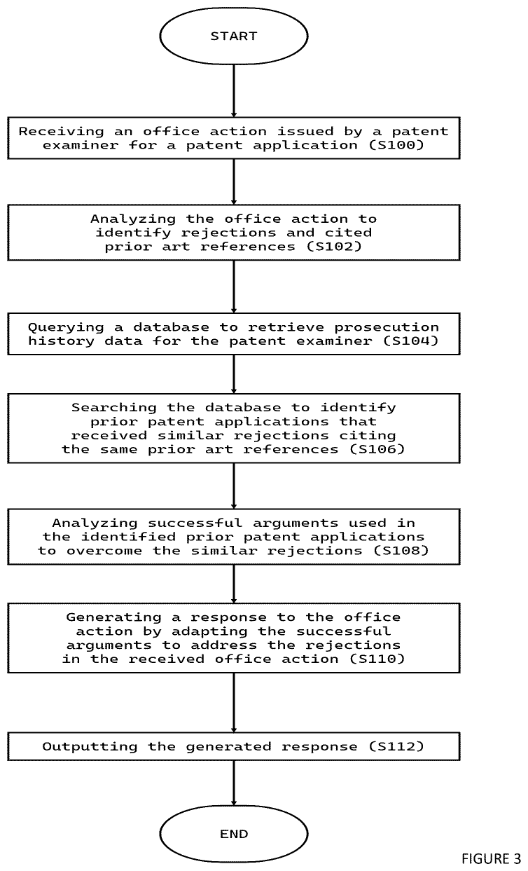

FIG. 3 illustrates a flowchart depicting another exemplary process for automated patent application response. The process includes steps such as receiving an office action issued by a patent examiner, analyzing the office action to identify rejections and prior art references, querying a database to retrieve prosecution history data, and searching for prior applications with similar rejections. It also involves analyzing successful arguments from those prior applications, generating a response by adapting these arguments, and outputting the generated response.

The process initiates with the receipt of an office action issued by a patent examiner concerning a patent application. This step involves obtaining formal communication from the patent office, which outlines specific rejections or objections related to the application. Upon receipt, the document is prepared for further analysis to identify the pertinent issues needing attention.

The method involves analyzing the received office action to identify the specific rejections it contains, as well as any prior art references that are cited. This step is for understanding the reasons behind the rejections and forms the basis for developing an effective response to the office action. By examining the detailed aspects of the identified rejections and cited references, a comprehensive analysis is facilitated, which enables the formulation of strategic arguments for overcoming the rejections.

The step of querying a database to retrieve prosecution history data for the patent examiner involves accessing stored data to gather relevant historical information. This data includes past interactions and decisions made by the examiner, which can offer insights into patterns or tendencies in their decision-making process. By analyzing this historical data, the system can identify strategies that have previously succeeded in overcoming similar rejections, thereby informing the formulation of the current response.

The reference label “analyzing successful arguments used in the identified prior patent applications to overcome the similar rejections S108” refers to a step where the system examines the arguments that were previously effective in overcoming similar rejections in other patent applications. By reviewing these successful strategies, the system can adapt them to address rejections in the current office action effectively.

The method involves generating a response to an office action by adapting successful arguments that addressed similar rejections in the past. This process includes analyzing previously successful strategies used in other patent applications to overcome similar objections. The adapted arguments are tailored to directly address the specific rejections mentioned in the received office action, ensuring a and effective response.

The method generates the response at S112. After analyzing the office action, retrieving the examiner's history, finding previous similar rejections, and incorporating successful arguments into a comprehensive response, this step is where the system delivers the crafted response. The output is generated to address the rejections identified in the received office action, presenting it in a format ready for review or submission.

The method involves a thorough analysis of the successful arguments presented in those prior applications that were effective in convincing the examiners to withdraw or amend the similar rejections. An in-depth review of the rationales, legal reasoning, and factual distinctions made in the successful arguments is undertaken to draw parallels with the current application's rejections.

Leveraging the findings from the analysis, a response is generated which carefully adapts the previously successful arguments to the specifics of the current application's rejections. This response is crafted to address each rejection point-by-point, weaving in nuances from the application at hand with demonstrated effective arguments from past applications to affirm the patentability of the claimed one implementation.

In the further expanded description of the method for responding to an office action issued by a patent examiner, one embodiment digs deeper into the strategic component of the approach by evaluating the tendencies of the patent examiner based on the prosecution history data. The acquired data not only includes instances of allowed and rejected claims but also provides a comprehensive overview of the patterns and leanings of the examiner regarding various types of rejections such as novelty, non-obviousness, and other statutory requirements.

The analysis involves a systematic examination of the examiner's previous decisions, where the prosecution history data becomes instrumental in discerning the allowance rate for the examiner in question, the frequency of specific rejections, and the likelihood of success of different types of arguments presented in past responses. This pattern recognition is to formulating a tailored response that aligns with the examiner's established evaluation criteria and preferences, thereby enhancing the probability of overcoming cited rejections.

Understanding an examiner's tendencies allows the preparation of a response that preemptively addresses potential objections and aligns the arguments with the type of rationale that the examiner has found persuasive in the past. This method encompasses preparing claims and arguments that are structured to meet the examiner's disposition, which may include highlighting specific aspects of one implementation that align with the allowed claims in similar contexts, fine-tuning claim language to avoid common pitfalls, and presenting arguments supported by relevant case law and statute that resonate with the examiner's decision-making patterns.

The value of this detailed analysis is profound as it equips applicants and their representatives with strategic insights that go beyond general legal and technical rebuttals. It ensures that the response to an office action is not only substantively but is also strategically aligned with the particular predilections of the reviewing examiner, thereby increasing the efficiency of the prosecution process and improving the odds of securing a patent grant.

This information, once analyzed and synthesized, undergirds the generation of a bespoke response to the office action, which may involve drawing parallels to successfully prosecuted analogous cases, deploying arguments that have historically resonated with the examiner, and poising the application structure in a manner that mirrors the characteristics of previously allowed claims. The generated response is then outputted, ready to be submitted to the patent office, representing a meld of substantive legal argumentation with prosecutorial strategy built from empirical data on the patent examiner's precedential decisions. By strategically employing the claim language and underlying arguments from successful prior applications, the current detailed description is augmented. This strengthens the underpinning for the claimed one implementation, thereby enhancing its likelihood of overcoming the objections raised by the patent office and moving towards allowance.

In assessing the tendencies of a patent examiner, certain metrics provide valuable insight into the examiner's approach to the examination process. One such tendency includes the examiner's allowance rate, which is a proportion representing the number of patent applications approved for a grant relative to the total number of patent applications reviewed. This rate is indicative of the examiner's overall receptiveness and propensity to allow patent applications to proceed to grant status.

Furthermore, another tendency to consider is the average number of office actions issued per patent application. An office action is a formal document sent by the patent examiner to the applicant during the prosecution of a patent application. It outlines the examiner's findings and any rejections or objections based on grounds such as lack of novelty, non-obviousness, or inadequacy in the specification or claims. The average number of office actions typically reflects the thoroughness and rigour of the examiner's scrutiny, as well as the complexity involved in bringing the application into compliance with patentability requirements. A higher average may indicate a more examination process, a propensity to require substantive amendments to the claims or specification, or the identification of issues that need resolution before advancing towards patent issuance.

Understanding these tendencies, the LLM can better anticipate the examination process and prepare a more application including comprehensive and clear disclosures and claims that are likely to align with the examiner's standards. This preparation can lead to a more efficient prosecution, potentially reducing the number of office actions required and increasing the likelihood of achieving allowance within the applicant's targeted timeline.

These examiner tendencies as identified by the database and LLM factored into the drafting and prosecution strategy. Applicants should strive to present a well-articulated patent application that preemptively addresses the concerns commonly raised by the examiner in office actions. As part of this, they should ensure that embodiments are sufficiently detailed and claims are defined to prevent ambiguity and streamline the examiner's review process. By doing so, applicants aim to align their applications with the identified tendencies of the examiner to facilitate a smoother path to patent grant.

The database, which forms a component of the system designed for the analysis and generation of responses to office actions, includes prosecution history data collected and maintained for a multitude of patent examiners operating within various art units of the patent office. This expansive dataset spans a wide breadth of technological areas, encompassing a diverse array of prior art, examiner citations, and documented interactions between patent examiners and applicants.

Moreover, the database is equipped with search algorithms enabling users to conduct targeted searches for prosecution histories involving particular examiners or art units. Users can query the database using a variety of parameters, such as specific rejections, claim language, or cited references, to find precedent cases and arm themselves with a comprehensive understanding of how similar matters have been previously adjudicated.

Through the collation of detailed examiner-specific data, the database aids patent practitioners in tailoring responses to the office actions in a manner that is both informed and strategic. It enables practitioners to pinpoint patterns or tendencies in examiner behavior, such as common rejections made by an examiner or successful strategies used by applicants to overcome such rejections. This not only fosters a more persuasive and individualized response to the office action at hand but ultimately contributes to a higher efficiency and success rate in prosecuting patent applications through the intricacies of the patent office's examination process.

The system can search its file history/PAIR database as part of responding to an office action. This process involves identifying prior patent applications that were examined by the same patent examiner and that were cited against the instant application due to the same prior art references. The LLM can reference analogous cases and leveraging historical examiner-specific data can lead to a well-reasoned and compelling response that addresses the intricacies of each rejection, thereby facilitating the navigation of the application toward allowance.

The examiner's history is analyzed by the LLM to glean patterns or precedents in the decision-making process of the examiner. The efficacy of past arguments and approaches employed by other applicants or their representatives can be instrumental in shaping the response. Identifying these prior patent applications is non-trivial and requires systematic examination of prosecution histories, where each application is a potential repository of knowledge. Patterns of allowance and rejection can offer a blueprint for effective response strategies.

The LLM can focus on the technical advantages and beneficial outcomes of one implementation are highlighted to reinforce the argument for patentability. This may involve drawing connections between the unique aspects of one implementation and the problem it seeks to solve, addressing any misconceptions or errors in the interpretation of one implementation or the prior art that may have been expressed by the examiner, providing the best possible foundation for the examiner to grant the patent.

The method can include analyzing interview summaries from the examiner's prosecution history data. This analysis aims to ascertain how receptive the examiner has historically been to applicant interviews during the prosecution process. Through a systematic examination of recorded interview summaries, one can deduce the examiner's tendencies towards certain argument types or negotiation techniques that may prove beneficial in advancing the patent application towards allowance.

By incorporating this analysis into the method for generating a response to an office action (reference signs S100-S112), the chances of presenting a compelling case to the patent examiner may be enhanced. The gathered intelligence could be used to tailor the response (reference signs S110 and S112) in a manner more likely to resonate with the examiner's known dispositions. For example, if the examiner is found to be especially amenable to visual demonstrations of an one implementation's features, the generated response could place greater emphasis on the visual aspects of the subject matter or include an invitation for an interview complemented by such demonstrations.

The process of analyzing interview summaries takes into account all relevant comments made by the examiner during these interviews. The particulars looked at may include any express mentions of challenges or points of contention that have been raised by the examiner, as well as any indications of parts of the application that are deemed satisfactory or any suggestions provided for overcoming the objections raised. This strategic assessment provides a valuable perspective that can be used to construct a deliberate and informed response to the office action, inherently increasing the likelihood of a successful negotiation with the examiner.

When an RCE (Request for Continued Examination) is filed, it provides another opportunity to negotiate with the patent examiner to seek allowance of the claims. Analyzing statistical data pertaining to the examiner's actions post-RCE allows an applicant to strategize their approach in response to an Office Action.

The analysis begins with the examination of the examiner's prosecution history, which is a wealth of information on how the examiner has responded to RCEs in the past. By utilizing this data, one can discern patterns or tendencies in the examiner's behavior, such as the likelihood of a patent being granted after an RCE is filed, the commonality of further interviews being conducted, or the propensity for which types of arguments have been successful in past negotiations following an RCE.

This information is because it helps to tailor the arguments in a manner that is more likely to be persuasive to the examiner based on empirical evidence. For instance, if the statistics indicate that the examiner tends to allow claims after considering certain types of amendments, such as those that clarify the scope or add limitations to the claims, the response can be configured accordingly.

Moreover, if statistics reveal that an examiner is more receptive to certain arguments post-RCE, for example, arguments related to commercial success or unexpected results, these can be emphasized in the response to the office action. Alternatively, if the data suggests that the examiner has a pattern of maintaining rejections even after RCE, this may prompt the applicant to consider pursuing other avenues, such as appeal or pre-appeal brief requests for review.

The LLM can examine the timelines associated with the examiner's past RCE reviews, as insights regarding the average time taken by the examiner to respond post-RCE can facilitate better time management and expectations for the applicant.

During the detailed description of a patent application involving RCE statistics, the content may be presented in a narrative that describes the process and findings of the analysis in depth. The description can recount how the database was queried to yield pertinent information about the examiner's historical responses to RCEs and the analysis performed on that data. Each step leading to the conclusion about the likelihood of successful prosecution strategies following an RCE with the examiner in question may be documented meticulously. Though no introductory aspects, headings, or text formatting can be applied to this narrative, the substance can still be conveyed through a careful explication of the analysis and its conclusions in the detailed description section of the patent application.

A prosecution strategy recommendation is formulated by leveraging the analysis of prosecution history data relevant to the patent examiner who issued the office action. This strategy is informed by identifying patterns, tendencies, and preferences in the examiner's past behavior with respect to similar rejections. Initially, the received office action is scrutinized to ascertain the specific grounds upon which the claims of the patent application have been rejected, with a particular focus on the cited prior art references. This includes a thorough review of both the rejections that are technical and substantive in nature as well as any procedural rejections that might be present.

Additionally, references cited in the office action are downloaded and provided to a language model, which is designed to further refine the drafted response by applying relevant rules from the Manual of Patent Examining Procedure (MPEP). The language model, upon analyzing the references and applying appropriate MPEP rules, ensures that all arguable points are appropriately addressed in the response. This step is particularly vital as it ensures that the response is not only scientifically and technically accurate but also adheres to the legal and procedural nuances required by the patent office.

Subsequent to the formulation of the drafted response and the application of the MPEP rules, the response is outputted for final review. At this sequence in the process, any additional adjustments or iterations are made to hone the response to the office action, ensuring that it is coherent, concise, and legally compelling in order to maximize the probability of a favorable outcome upon re-examination by the patent examiner.

As part of the prosecution strategy recommendation to address an office action for a patent application, it may be advisable to engage in direct communication with the patent examiner through an examiner interview. This approach offers an opportunity to clarify any ambiguities and directly address the examiner's concerns, which could lead to a more expedited and favorable outcome.

Conducting an examiner interview can also provide an avenue for discussing the potential for allowable subject matter. By understanding the examiner's perspective, the applicant can tailor the claims and arguments to align with the examiner's interpretations and requirements, potentially leading to a more positive outcome. To minimize file history estoppel, the system prints the draft for discussion with the examiner as a viewable only document marked as “for discussion only” so that the document cannot be placed in the file after the discussion.

To formulate an appeal, it's imperative to scrutinize previously issued office actions, identified by reference number 104, to uncover past interactions between the examiner and the applicant, as well as to search for historical data related to similar rejections, denoted by 106. Such an examination includes analyzing successful arguments, indicated by reference 108, that have effectively overcome analogous rejections in the past. This process aims to discern patterns or tendencies in the examiner's decision-making, as well as finding arguments that have been persuasive in reversing rejections of similar nature.

If previous office actions, the current state of the application, and the outcomes of similar cases suggest that further prosecution is unlikely to result in allowance, a calculated decision is made to recommend an appeal to the Patent Trial and Appeal Board (PTAB). This recommendation takes into account the potential benefits and risks, including the possibility of achieving a favorable outcome through argument and the chance of further clarifying the legal issues at stake. The appeal process itself may encompass submitting a brief that thoughtfully addresses the legal and technical arguments, and it may culminate in an oral hearing where such arguments can be presented directly to a panel of judges.

The suggested appeal encapsulates a strategic maneuver in the patent prosecution lifecycle, poised to overcome impasses and strive towards the grant of a patent. The recommendation is woven into the narrative of the detailed description, serving to elucidate the applicant's steadfast belief in the patentability of one implementation and readiness to defend the concepts before higher authorities. Through this vigorous process, the applicant manifests a commitment to securing and preserving the intellectual property rights that underpin the novelty, non-obviousness, and industrial applicability of the claimed one implementation.

The detailed description of one implementation herein is further improved by the addition of a mechanism that aids in the comprehension and strategic planning of the patent application process. An innovative aspect of this one implementation encompasses the generation of a visual timeline, an illustrative representation that documents the chronological sequence of events in the prosecution history of a patent examiner. By systematically organizing and presenting the examiner's previous interactions with patent applications, including but not limited to office actions received, responses filed, and subsequent decisions, the visual timeline provides an intuitive and accessible overview of the examiner's patterns and tendencies.

Simultaneously, one implementation extends its capabilities by integrating a method for forecasting an estimated timeline until the allowance of a patent application. This prediction is grounded in a thorough analysis of data from the examiner's prosecution history. The algorithm employed for this calculation takes into consideration various metrics, such as the frequency and types of rejections issued, response times, the ratio of allowances to rejections, and any patterns discerned regarding the examiner's responsiveness to different arguments. By assimilating this information, the system yields an informed estimate of the time remaining until a potential allowance of the application under examination.

The described features significantly enhance the applicant's ability to tailor their approach in responding to an office action. With the visual timeline, applicants can readily identify where their application stands in relation to the common trajectory overseen by the specific examiner. Moreover, the estimated time to allowance function allows applicants to set realistic expectations for the patent application timeline and to plan accordingly for potential contingencies.

The utilization of an LLM in this context serves to harness its computational and analytical proficiency, as it is adept at processing extensive legal text and extracting actionable insights. To effectively traverse the rejections, the method additionally encompasses the application of one or more rules as prescribed by the Manual of Patent Examining Procedure (MPEP). These rules are systematically applied to each reference in a manner that aligns with their corresponding applications in previously adjudicated patent claims.

In sum, the above implementation refines the method of formulating responses to office actions by incorporating technological aids that significantly improve the likelihood of overcoming the rejections and advancing towards the grant of a patent. This streamlined and rigorous approach to patent prosecution positions the method as an tool for practitioners. The method further comprises identifying allowed claim language from other patents within the same art unit that previously overcame rejections similar to the ones currently being issued. This identified claim language serves as a strategic guide for amending or arguing claims in the subject application. It involves conducting a search through databases that contain issued patents and published applications, pinpointing the successful claims that addressed objections parallel to the ones at hand—a task especially when the rejections are predicated on substantial prior art findings or issues of patentability, such as nonobviousness or subject matter eligibility. Once similar rejections and how they were overcome are identified, the allowed claim language can be analyzed to determine the differences between the cited prior art and the claimed one implementation that justified allowance of the claims. This involves dissecting the allowed claim language to understand the arguments and claim features deemed persuasive by the examiners, linking those features or arguments to the aspects of one implementation that differentiate it from the prior art, and justifying their inclusion in the application. By tailoring the identified allowed claim language to fit the context of the current application, including the and non-obvious features of one implementation, an applicant can fortify the response to the office action. This adapted claim language is then incorporated into the detailed description section of the patent application. The detailed description must describe one implementation in such full, clear, concise, and exact terms as to enable any person skilled in the art to make and use the same. This section of the application is a part that teaches the public how to practice one implementation and can be expanded or refined, using the identified allowed claim language as a beacon, to more convincingly delineate one implementation from the prior art, thus aiming to facilitate the patent's allowance. In the detailed description of one implementation, a method is disclosed for enhancing the process of responding to an office action in patent prosecution by generating a comparison of an examiner's statistics to the averages of the examiner's respective art unit. This comparative analysis is a tool in formulating responses to office actions, as it provides applicants and their representatives with insights into the examiner's decision-making patterns and tendencies, in the context of the broader tendencies of the art unit in which the examiner operates.

At the of the method is the collection and analysis of data, which includes performance metrics such as allowance rates, interview success rates, frequency of different types of rejections, and average times to disposition for both the specific examiner as denoted at S104 and the examiner's art unit. This statistical information forms the basis for the comparison generated. The comparison provides a clear understanding of whether the examiner's actions are consistent with the norms of their art unit or if they deviate from those norms in any significant manner.

Upon receipt of an office action S100, the method includes amalgamating the received rejections S102 with historical data S104, involving both the examination history of the present application and the identified examiner's history. The retrieval of this information is facilitated through querying a database that maintains prosecution histories of patent examiners and art units. The comparison also takes into account how other applicants have successfully traversed rejections made by the same examiner, providing practical insights and proven strategies that can be adapted to the current application's circumstances S108. These strategies include, but are not limited to, argumentative responses, claim amendments, and the presentation of additional evidence or declarations that have previously been persuasive in overcoming similar rejections S106.

Furthermore, the comparison considers the efficiency of responses to the office action. It facilitates the preparation of a targeted response S110 that selectively addresses the issued rejections by tailoring arguments that are statistically more likely to lead to allowance based on the examiner's record as well as the trends within the art unit. The comparison thus serves to improve the efficacy of the arguments presented in the response to the office action by adapting them to the specific inclinations of the examiner relative to their peers S112.

These comparative insights provide applicants with an empirical foundation upon which to base their prosecution strategies. This data-driven approach to patent prosecution maximizes the likelihood of advancing the application toward allowance, while minimizing the expenditure of resources and time otherwise consumed by less targeted, less informed response methods.

The cumulative effect of implementing such comparative analysis into regular patent prosecution practice is expected to lead to higher rates of successful patent prosecution outcomes for applicants, as the responses to office actions are better informed, more crafted, and aligned with the specific behavioral patterns of both the assigned examiner and the examiner's art unit.

In implementing this method, it may also involve machine learning or artificial intelligence systems to further refine the comparison, potentially identifying nuanced patterns that might not be readily apparent through a straightforward statistical comparison S1702. With the evolving nature of patent prosecution strategies, the capacity to adapt and learn from each unique interaction with the patent office becomes ever more in achieving favorable outcomes in the patent procurement process.

The generated response 112 includes proposed claim amendments that have been crafted utilizing a language model, specifically a Large Language Model (LLM). This approach ensures that the amendments are not only and relevant to the subject matter of the claims, but also addresses each rejection as asserted by the patent examiner in the office action 100.

The proposed claim amendments are calibrated to alleviate the concerns raised in the office action. Each amendment is underpinned by supporting arguments designed to directly map onto the examiner's objections. For example, if the examiner has rejected a claim based on the grounds of obviousness, the supporting argument would articulate why the amended claim elements, when considered as a whole, exhibit an step that is not obvious to a person having ordinary skill in the art. The textual presentation of these arguments leverages the technical language and legal principles outlined in the Manual of Patent Examining Procedure (MPEP), and strategically presents the patentability of the amended claims.

Additionally, these amendments and supporting arguments seek to advance the understanding that the proposed claims, as amended, are fully supported by the originally filed specification, ensuring compliance with 35 U.S.C. § 112(a), which necessitates a written description of one implementation that enables a person skilled in the art to which it pertains to make and use one implementation. To achieve this, the claim amendments are accompanied by a clear cross-reference to the corresponding content in the detailed description, demonstrating that the substance of the amended claims was disclosed in the manner required by the USPTO's patent standards.

This strategy not only reinforces the applicant's position for allowable claims but also fortifies the narrative that the application, as a whole, meets the substantive requirements of patentability, thus advocating for the advancement of the application towards grant.

The system creates a lean methodology canvas for a patent application which involves charting a strategic roadmap that aligns the proposed one implementation with potential market opportunities. The canvas typically explores elements such as customer segments, value propositions, channels, customer relationships, revenue streams, resources, activities, partnerships, and cost structure. For a patent or patent family, the canvas is utilized to identify potential licensees who may have an interest in the commercialization of the technology or one implementation described by the claims. In doing so, it helps to establish a business case for the patent, which can be particularly useful when approaching potential investors or partners.

In connection with the patent application, the detailed description section furnishes a comprehensive account of one implementation, providing enough information for a person skilled in the art to practice one implementation. The detailed description explicates how the claimed one implementation fulfills a need within the market as identified by the Steve Blank canvas, elucidates the principles and operation of one implementation, and offers specific examples or embodiments. While developing the detailed description, the LLM checks that claimed elements are thoroughly described, outlining how they can be made and used, the method of operation, and the innovative technical advantages they present.

Through the detailed description, each element of the claim should be examined by referencing the supporting embodiments and any experimental data or hypothetical use cases that can substantiate the patentability and utility of one implementation. Without resorting to headings, text formatting, or an introductory segment, the detailed description seamlessly flows from technical aspects and workings of one implementation to practical applications and potential markets, focusing keenly on the functional and structural characteristics. It describes how one implementation can be replicated and the manner in which it can yield the benefits encapsulated in the canvas.

The traversing of complex technological concepts into easily understandable language, while concurrently satisfying the legal requirements for patent disclosure, constitutes the central challenge of drafting the detailed description. The technical details that universally establish the framework of one implementation, alongside any preferable modifications or variations without deviating from the concept, are delineated plainly but with sufficient technical precision to preempt ambiguity. Moreover, the description typically correlates directly to the Steve Blank canvas by expatiating on those features which make one implementation desirable and beneficial from a licensee's standpoint, thereby underscoring the potential value proposition for commercial exploitation as contemplated by the claims.

As each sheet includes the labeled parts, the reference signs are identified by the visual language model. The labeled parts are indicated with corresponding reference characters that are consistent throughout the patent application. These drawing sheets serve to visually support the technical descriptions provided in the detailed description section of the patent application, and are prepared in accordance with the MPEP or the EPO regulations. Each drawing sheet illustrates the components and features of one implementation as depicted in the extracted images, and the labels help to guide the reader in understanding the relationships between different parts of one implementation.

When preparing a patent application based on the innovative content of a scientific publication, the claims are searched for patentability and form a solid foundation for a intellectual property asset that may attract prospective licensees. Expanding upon the previously claimed content entails a thorough understanding of one implementation and potential prior art, providing a detailed description aligning with the MPEP or EPO standards.

The detailed description commences with an elucidation of one implementation as disclosed in the scientific publication, explicating the innovative features and technical advancements over the prior art. One implementation is described in full, clear, concise, and exact terms, allowing any person skilled in the pertinent art to make and use the same.

terms that are central to the credibility and understanding of one implementation are extracted from the scientific publication. These terms serve as the nexus to performing an assiduous patentability search. The exhaustive search identifies relevant prior art and enables the inventor and patent professionals to discern the novelty and non-obviousness of one implementation over known technologies.

The search results are analyzed, and claims are crafted to encapsulate the aspects discovered. Each claim is drafted to clearly define the metes and bounds of one implementation, outlining not only the innovative steps or components but also how they interrelate to achieve the desired objective of one implementation.

Upon crafting an initial set of claims, a prospective claim chart is created. This chart juxtaposes the drafted claims against the found prior art, methodically examining each element of the claims and their correspondence with or distinction from the prior art. This juxtaposition not only aids in refining the claim language to bolster its strength and enforceability but also serves as a demonstrative tool for prospective licensees to comprehend the scope and boundary of the intellectual property they may adopt.

The resulting claims are incorporated into the non-provisional patent application, and a comprehensive detailed description is provided, articulating the specification without resorting to headings or text formatting that might detract from the gravitas of the document. The description delineates the technological field of one implementation, followed by a summary of the aspects that impart a superior advantage, progressing to expound upon the working, structure, and interconnections of one implementation's features in consonance with the claims, thereby laying bare the plain fullness of one implementation to the satisfaction of the USPTO requirements and facilitating the understanding of interested parties.

The detailed description thus entails a careful balancing act between technical precision and legal acumen, ensuring that each aspect of one implementation is disclosed in a manner that both satisfies the legal standards of patentability and provides a disclosure that fully supports the claims and serves the interests of the inventor and potential licensees alike.

In accordance with aspects of one implementation, the method further comprises the generation of an information disclosure statement that enumerates and lists various references as were cited within the scientific publication under consideration. This information disclosure statement functions as a clear and concise articulation of the relevant prior art or background information that could potentially bear on the patentability of one implementation as claimed. The submission of this statement assists the patent examiner in comprehensively understanding the context and the novelty of the proposed one implementation by providing them with direct referents to prior works that have been acknowledged by the inventors themselves.

The details incorporated into the disclosure statement are chosen to reflect literature, patents, patent applications, publications, or any form of published content that the inventors or applicants consider pertinently related to the subject matter of one implementation. It encompasses a breadth of references ranging from scientific journals, articles, textbooks, conference proceedings, web publications, and any corpus that can be feasibly accessed for examination by the United States Patent and Trademark Office. This diligently curated list is intended not only to fulfill the duty of candor and good faith but also to inform the patent examiner of the technological landscape against which the current one implementation is juxtaposed.

The references enumerated within the information disclosure statement are particularly relevant, as they have been mobilized within the scientific publication from which one implementation draws. By including this publication as a reference point, the response implicitly acknowledges the scientific discourse from which one implementation emerges. The act of generating such a statement postulates a proactive approach wherein the disclosure of related art is considered a high priority, thus ensuring that all art known to the applicant which is likely to be relevant to the examination of the application is promptly and efficiently brought to the attention of the examiner.

In attending to the generation of the aforementioned statement, the method ensures that all cited references are methodically listed, each accompanied by a brief indication of its pertinence to one implementation. Such a discourse allows for a and forthright engagement with the patent examination process, fostering an environment wherein the merits of one implementation can be rightly adjudicated in light of known technology, thereby facilitating a just outcome in the patent grant process.

The disclosed technology further comprises a step of applying optical character recognition (OCR) to any images containing text within the digital document to extract the text. The OCR process converts various types of documents, such as scanned paper documents, PDF files or images captured by a digital camera, into editable and searchable data.

Upon extracting the text from the images, the system ensures that the content represented in the images is accurately transposed into machine-readable characters. This text extraction allows for the substantive content contained within the images to be analyzed, indexed, and utilized in the creation of the patent application. The OCR technology applies algorithms that not only recognize and convert printed or handwritten text into machine-encoded text but also distinguish the textual content from graphics and decorative elements within the images.

The extracted text can then be integrated into the detailed description section of the patent application, enabling it to contribute to the disclosure of one implementation. The detailed description elaborates on one implementation in a full, clear, concise, and exact manner to allow a person skilled in the art to both make and use one implementation, and it sets forth the best mode contemplated by the inventor of carrying out one implementation.

The detailed description provides an extensive elaboration of each aspect of one implementation as gleaned from the analysis of the scientific publication, including any insights derived from the OCR-processed images. This includes a comprehensive discussion of the structure, composition, functionality, and operation of one implementation, as well as its practical applications and embodiments. The description may also discuss the relationship between the components of one implementation, intended interactions, and the results achieved using various configurations of one implementation, as informed by the text extracted from the images.

Furthermore, the OCR-extracted text enriches the technical content of the patent application by providing additional specificity and support to one implementation's claims. The extracted text ensures that no details are overlooked and that the detailed description is complete in capturing all aspects of one implementation. By including the OCR-extracted text in the detailed description, the application is bolstered with rich, detailed content, thereby enhancing its technical disclosure and supporting the patent claims.

Further comprising the step of generating multiple claim sets of varying scope based on the content of the scientific publication, wherein the multiple claim sets include a first claim set with a broad scope, one or more intermediate claim sets with progressively narrower scopes, and a final claim set with a narrow scope, thereby providing a graduated series of protective barriers to the intellectual property disclosed in the scientific publication, the broad scope claims being drafted to encompass a wide range of potential variations on the innovation, the intermediate claim sets providing protection for specific embodiments, variations, or applications of the innovation that are more specifically defined than the broadest claims but less specifically defined than the narrowest claims, and the narrow scope claims being tailored to cover specific implementations of the innovation characterized by particular technical features, limitations or use cases that are disclosed in the scientific publication and are to its novelty and non-obviousness.

The digital document, which can be in PDF or LaTex format, offers a comprehensive compilation of data relevant to one implementation at hand. This document encompasses a range of information such as experimental results, diagrams, explanations of technical concepts, mathematical formulations, and empirical data-all of which collectively elucidate the underlying principles and practical applications of one implementation. The text, illustrations, and any supplementary materials in this digital document are crafted to provide a clear and complete understanding of one implementation's structure, functionality, and benefits.

One implementation embodies features that are set forth with particularity herein. The detailed descriptions are not meant to be restrictive but rather to serve as representative examples for clarity purposes. It is to be understood that various changes in form, detail, and operation may be made without departing from the spirit and scope of one implementation.

Any numerical values mentioned in the detailed description reflect specific embodiments and are provided as examples. These values can be varied within the scope of one implementation, and the embodiments are not limited to the values disclosed. Furthermore, while certain features may be described in conjunction with specific embodiments or figures, they may be combined with others in alternative embodiments whether explicitly described or not.

References to “an embodiment,” “one embodiment,” “some embodiments,” or “various embodiments” mean that the particular feature, structure, or characteristic being described is included in at least one embodiment of one implementation. Such phrases are not necessarily all referring to the same embodiment, nor are they separate or alternative embodiments mutually exclusive from other embodiments. Moreover, the absence of these phrases does not preclude embodiments from having the described features.

The detailed descriptions provided take into consideration the full purview of the digital document and amalgamate the content therein to represent one implementation in its entirety. To the best of the knowledge provided by the records and in the most coherent and intelligible structure possible, these descriptions endeavor to showcase one implementation in a light that adequately and justifiably explains the and steps, as well as the utility that one implementation affords.

A computer-implemented method enables the transformation of a scientific publication into a non-provisional patent application by carrying out a series of innovative steps that synthesize the complexities of both scientific innovation and patent law into a consolidated document ready for submission to a patent office.

At the initiation of the process, images integral to the scientific publication are extracted from the digital document which embodies the publication. The visual elements, often being diagrams, graphs, or photographic evidence, are for the understanding of the scientific breakthrough and for substantiating claims of novelty and step within the patent application.

Building upon the foundation laid by the images and their descriptions, patent claims are crafted. These claims consolidate the content within the scientific publication and the corresponding images into legally recognisable assertions about what is being claimed as one implementation. The precision in claim language correlates directly to the potential enforceability and scope of the resulting patent right.

Before these claims are cemented into the application, they are presented to a user, typically the inventor or a patent professional, for approval. This review process ensures that the generated text accurately captures the essence of the scientific advancement and aligns with the strategic objectives of the patent applicant.

Once user approval is secured, a language model is employed to construct the full patent application specification. This specification is a hybrid legal and technical document that illustrates one implementation in full, leveraging the approved claims, the extracted images, the brief descriptions of each image, and the labelled image parts to provide disclosure that extends beyond the claims and into the larger embodiment of one implementation.

Finally, the non-provisional patent application is generated. It is a compilation that weaves together the background-placing one implementation within the context of what is already known; the summary-emphasizing the aspects of one implementation; the brief description of the drawings-explicating each image; the detailed description-closing the gap between the overarching concept and the pragmatic disclosure; and the claims-defining the legal boundaries of the patent. The extracted images, serving as both visual aids and definitional tools, are integrated into the application to provide clarity and reinforce the written narrative.

This exemplifies the innovative method in which proprietary technological solutions can evolve the conventional practices of drafting patent applications by automating the transition from scientific research to patent protection. Through this process, the integrity of the scientific advancement is not only preserved but also is translated into the jurisprudential framework required for patent applications, fostering technological advancement and supporting the protection of intellectual property rights.

In a further aspect, an AI agent designed to facilitate patent licensing by analyzing claims, creating claim charts, identifying prospective licensees, and providing a contact system to promote the patent's business value. This agent would integrate various AI technologies and databases to create a comprehensive patent licensing strategy. The agent ingests claims from a family of patents using natural language processing (NLP) techniques. It parses and analyzes the claims to understand the concepts and technical features. The agent identifies terms, components, and processes described in the claims. Using the analyzed claim data, the agent automatically generates detailed claim charts. It breaks down each claim into individual elements or limitations. The agent creates a table with claim text in the left column, leaving space in the right column for mapping to potential products or prior art. The agent conducts comprehensive market research to identify industries and companies that could benefit from the patented technology. It uses FAISS-based similarity search to find companies whose products or services align with the patented technology. The agent analyzes company profiles, product lines, and market positions to rank potential licensees based on likelihood of interest and ability to commercialize the technology. The agent gathers relevant contact details for decision-makers at potential licensee companies. It uses web scraping techniques and integrations with professional networks (e.g., LinkedIn, Crunchbase) to collect up-to-date contact information. The agent ensures compliance with data privacy regulations in its data collection and storage processes. The agent creates personalized email templates and LinkedIn ad copy using NLP models fine-tuned on successful licensing outreach campaigns. It tailors the message to each potential licensee, highlighting how the patented technology can enhance their specific business operations or product offerings. The agent emphasizes the mutual benefits of licensing the patent, adapting the pitch to each company's market position and strategic goals. For each prospective licensee, the agent conducts a detailed analysis of how the patented technology could enhance their business. It identifies potential applications of the technology within the licensee's product line or services. The agent estimates potential cost savings, revenue increases, or competitive advantages that could result from implementing the patented technology. The agent integrates with email marketing platforms and LinkedIn Ads API to execute the outreach campaign. It monitors response rates, engagement metrics, and feedback from potential licensees. Based on the responses, the agent refines its approach and messaging for future outreach efforts. For interested parties, the agent provides additional information and coordinates follow-up communications. It can generate preliminary licensing terms based on industry standards and the specific value proposition for each potential licensee. The agent assists in scheduling meetings or calls between the patent holders and interested licensees. The agent implements a centralized knowledge base to capture outcomes and feedback from licensing efforts. It uses this data for continuous model refinement and strategy optimization, improving its performance over time. This AI agent would significantly streamline the patent licensing process by automating many of the labor-intensive tasks involved in claim analysis, licensee identification, and outreach. By leveraging NLP techniques, market research capabilities, and personalized communication strategies, it can effectively match patents with potential licensees and articulate the value proposition in a compelling manner. This approach allows patent holders or technology transfer offices to focus on high-level strategy and relationship building while the AI agent handles the bulk of the research, analysis, and initial outreach efforts.

One method for facilitating patent licensing and infringement analysis using an artificial intelligence system includes receiving a set of patent claims from a family of patents; analyzing the patent claims using natural language processing to identify technical features; generating claim charts based on the analyzed patent claims; utilizing a dynamic Mixture of Experts (MoE) system to route specific infringement analysis tasks to specialized models; conducting an AI-driven infringement analysis by comparing the technical features to products or services in the market; identifying prospective licensees or potential infringers based on the infringement analysis; creating personalized outreach materials for each prospective licensee or potential infringer, highlighting specific technical implementations that may be of concern; initiating contact with the prospective licensees or potential infringers to promote licensing opportunities or address potential infringement; and continuously updating a centralized knowledge base with outcomes and feedback from licensing and infringement analysis efforts to refine the AI system's performance.

Another method for enhancing patent licensing and infringement analysis using an artificial intelligence system includes receiving, by a computer system, a set of patent claims from a family of patents; analyzing, using natural language processing techniques implemented by the computer system, the patent claims to identify technical features; generating, by the computer system, structured claim charts based on the analyzed patent claims; implementing a dynamic Mixture of Experts (MoE) system with a FAISS-based gating mechanism to route specific infringement analysis tasks to specialized models within the computer system; decomposing, by the MoE system, the infringement analysis task into sub-tasks and dynamically routing each sub-task to the most appropriate expert model based on semantic similarity; conducting, by the specialized models, an AI-driven infringement analysis by comparing the technical features to products or services in the market; identifying, based on the infringement analysis, prospective licensees or potential infringers; generating, using natural language processing models fine-tuned on successful licensing campaigns, personalized outreach materials for each prospective licensee or potential infringer; initiating contact with the prospective licensees or potential infringers through integration with email marketing platforms and social media sites; implementing a centralized knowledge base within the computer system to capture outcomes and feedback from licensing and infringement analysis efforts; and continuously updating the AI system's performance by retraining the specialized models using the captured data.

A further method for enhancing patent licensing and infringement analysis using an artificial intelligence system includes receiving, by a computer system, a set of patent claims from a family of patents; analyzing, using natural language processing techniques implemented by a large language model (LLM) within the computer system, the patent claims to identify technical features; generating, by the LLM, structured claim charts based on the analyzed patent claims; conducting, by the specialized components of the LLM, an AI-driven infringement analysis by comparing the technical features to products or services in the market; identifying, based on the infringement analysis, prospective licensees or potential infringers; generating, using the LLM fine-tuned on successful licensing campaigns, personalized outreach materials for each prospective licensee or potential infringer; and contacting the prospective licensees or potential infringers through integration with marketing platforms and social media sites.

Implementations of the method can include one or more of the following:
a. utilizing a mathematical reasoning layer within the LLM to process symbolic computations and complex equations related to the infringement analysis;
b. implementing a centralized knowledge base within the computer system to capture outcomes and feedback from licensing and infringement analysis efforts;
c. continuously updating the LLM's performance by retraining on the captured data and generating synthetic data based on observed licensing patterns; and
d. adapting the LLM's outputs based on user feedback and historical interactions to provide tailored responses for patent licensing and infringement analysis.
e. the analyzing the patent claims includes parsing the claims to identify individual elements and limitations.
f. the generating claim charts includes creating a table with claim text in one column and space for mapping to potential products in another column.
g. the identifying prospective licensees includes using a FAISS-based similarity search to find companies whose products or services align with the patented technology.
h. ranking potential licensees based on likelihood of interest and ability to commercialize the technology.
i. the creating personalized outreach materials includes generating email templates and advertising copy using natural language processing models fine-tuned on successful licensing campaigns.
j. retrieving contact information for decision-makers at prospective licensee companies using web scraping techniques and professional network integrations.
k. conducting a business enhancement analysis for each prospective licensee to identify potential applications of the patented technology within their product line or services.
l. the business enhancement analysis includes estimating potential cost savings, revenue increases, or competitive advantages that could result from implementing the patented technology.
m. initiating contact includes integrating with email marketing platforms and social media advertising APIs to execute outreach campaigns.
n. monitoring response rates and engagement metrics from the outreach campaigns.
o. refining the outreach approach and messaging based on the monitored response rates and engagement metrics.
p. generating preliminary licensing terms based on industry standards and the specific value proposition for each potential licensee.
q. assisting in scheduling meetings or calls between patent holders and interested licensees.
r. implementing a centralized knowledge base to capture outcomes and feedback from licensing efforts.
s. using data from the centralized knowledge base for continuous model refinement and strategy optimization.
t. analyzing the patent claims includes utilizing a dynamic Mixture of Experts (MoE) system to route specific analysis tasks to specialized models.
u. identifying prospective licensees includes decomposing the task into sub-tasks and routing each sub-task to the most appropriate expert or model based on semantic similarity.
v. generating synthetic data based on observed licensing patterns to enhance the system's ability to handle emerging tasks.
w. implementing an incentive-based user ecosystem that rewards quality contributions to improve the patent licensing process.

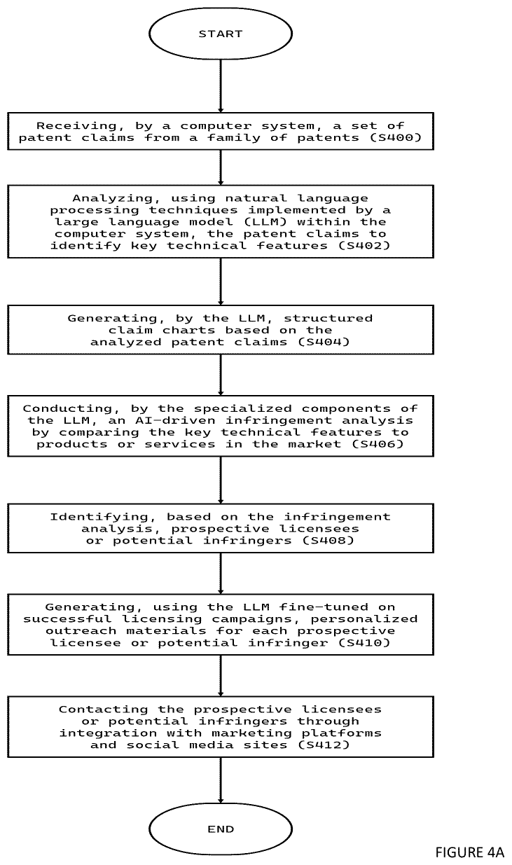

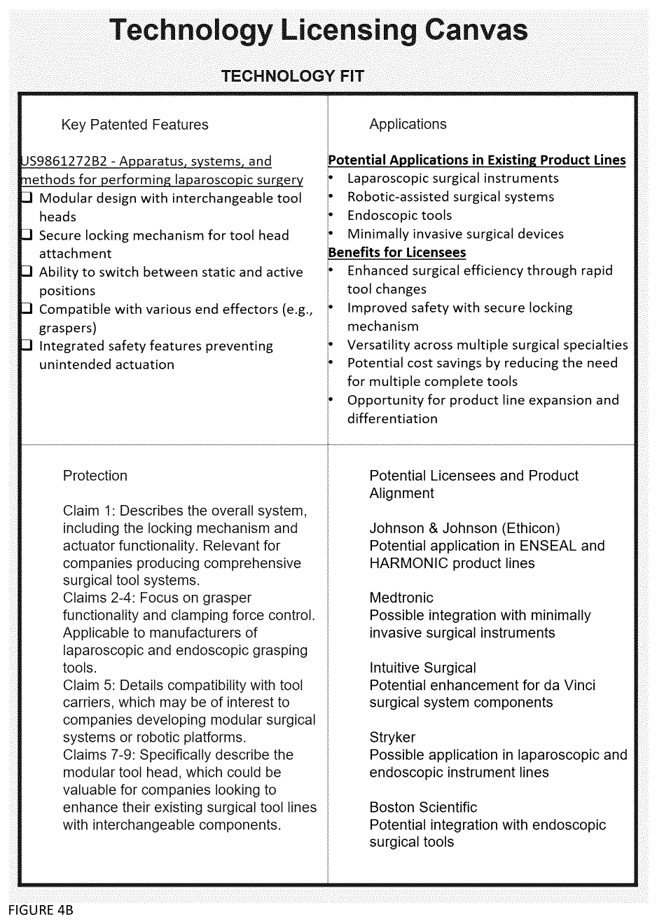

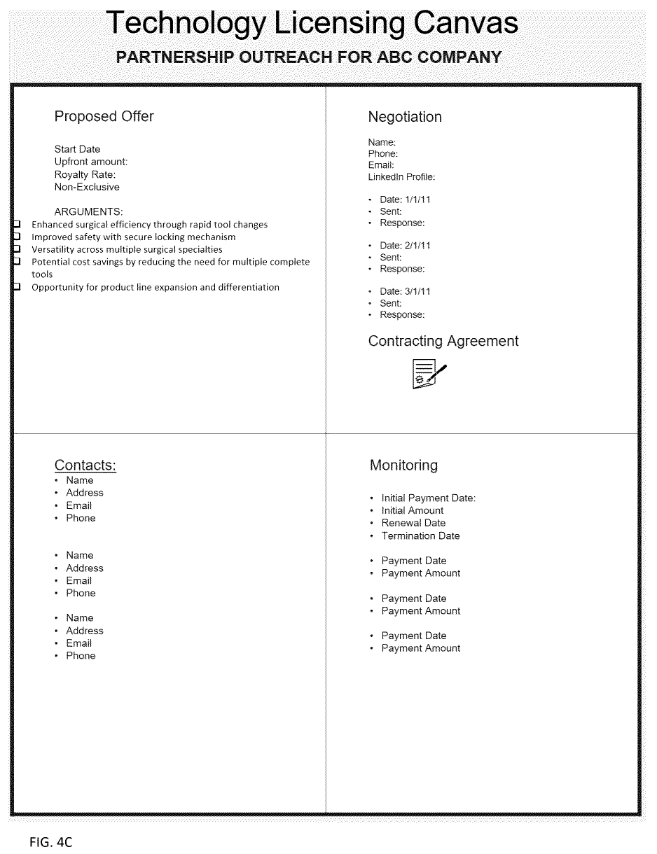

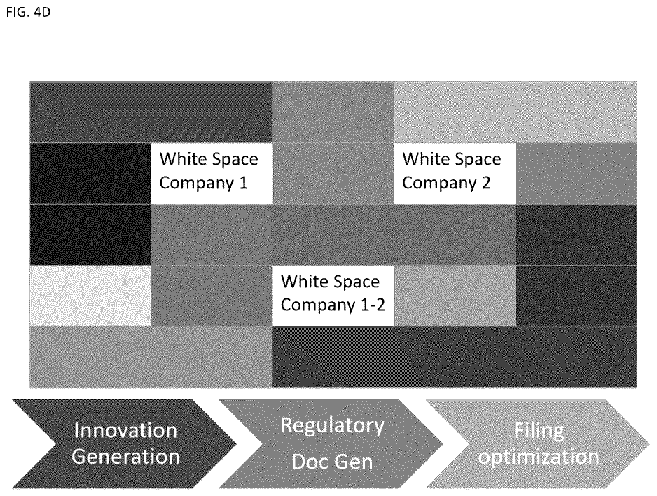

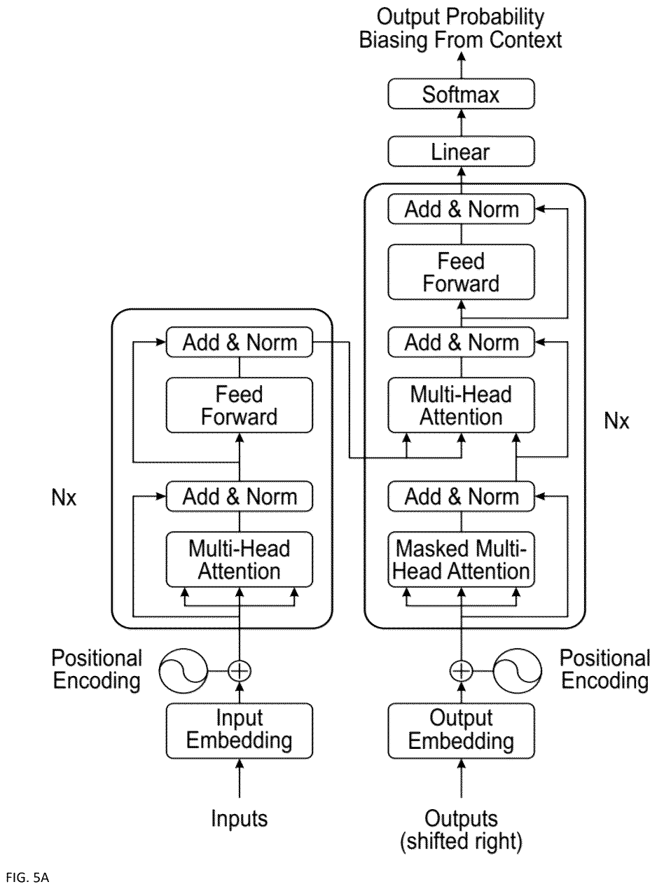

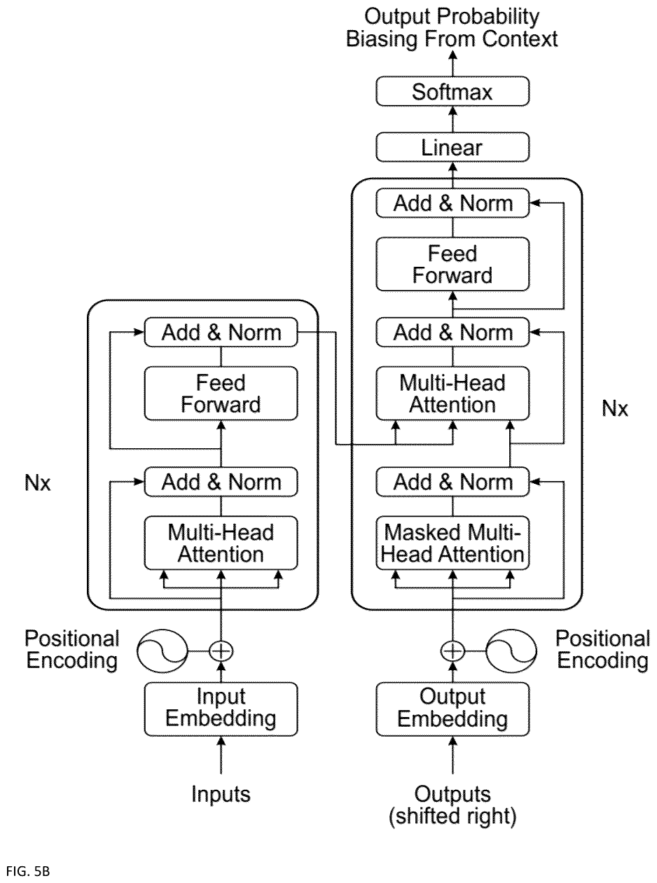

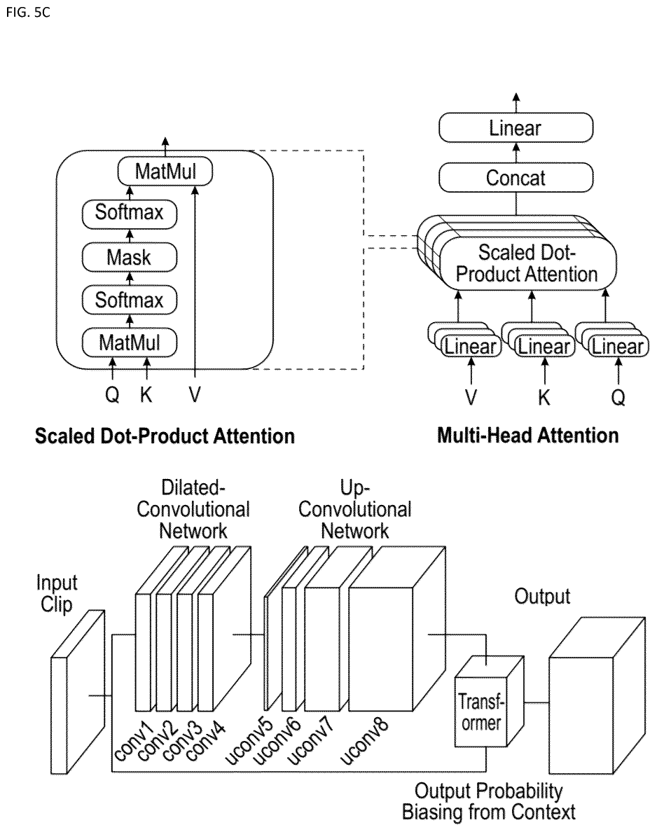

FIG. 4 shows a flowchart depicting an AI-driven process for persuasive licensing offer with patent claims analysis and infringement identification. One implementation commences its workflow with operation S400, wherein a computer system equipped with algorithms is tasked with the initial stage of procuring a collection of patent claims. This collection emanates from a family of patents, providing a diverse spectrum of intellectual property for the AI system to parse and understand. This step lays the groundwork for the subsequent analysis and is instrumental in ensuring that a broad and representative sample of patents is used for the evaluations to follow. By gathering these claims, the system ensures that the foundation upon which further analysis is built is both comprehensive and robust, thus optimizing the accuracy and relevance of the insights generated by this method.

One implementation introduces a method that uses AI to improve the way patent licensing and infringement analysis is conducted. In a particular embodiment, the method encompasses a step designated as S402, wherein a computer system equipped with a large language model (LLM) undertakes the task of scrutinizing patent claims. This computer-implemented process utilizes the capabilities of natural language processing (NLP) to analyze the text of the patent claims with the objective of pinpointing the technical features that define the scope and novelty of the patent. This nuanced analysis facilitated by the LLM is for distilling the complex language of patent claims into a set of discernible, elements. These elements serve as the backbone for subsequent stages of infringement assessment and for the identification of potential licensing opportunities in the market. The integration of NLP techniques into the LLM ensures that the nuances and specific terminologies inherent in patent literature are thoroughly understood and accurately interpreted, thereby furthering the reliability and precision of the subsequent infringement analysis and licensing endeavors.

The present innovation introduces a method for leveraging artificial intelligence to streamline the process of patent licensing and infringement analysis. Central to this method is step S408, where the AI system embarks on the task of identifying prospective licensees or potential infringers following an infringement analysis. Upon conducting a detailed comparison of technical features extracted from patent claims against existing products or services, the AI identifies entities that are potentially utilizing the patented technology. This identification is rooted in a comprehensive analysis which contemplates the nuanced correlations between patented features and their possible embodiments in the market. The result of this step is a curated list of parties who may be interested in licensing the technology or who might be infringing upon the patent. This list serves a function in the broader scope of the patent enforcement strategy, forming the foundation upon which targeted outreach and licensing negotiations can be constructed.

The approach recognizes the importance of personal connection and efficient communication. To this end, the AI system capitalizes on its nuanced understanding of successful patent licensing strategies by creating personalized outreach materials for each identified party, referenced as S410. It is the final stage, captured under the reference label S412, where the system truly shines by seamlessly integrating with a variety of marketing platforms and social media sites. This integration allows for direct and impactful engagement with prospective licensees or potential infringers, ensuring that the tailored outreach materials reach their intended audience with precision, thereby facilitating productive interactions and fostering opportunities for licensing agreements or resolution of infringement issues.

Initially, the computer system is tasked with receiving a set of patent claims that belong to a family of patents. These claims represent the technological scope and the boundaries of the intellectual property rights granted or sought by the patents in question. The primary objective is to assess these claims to pinpoint licensing opportunities or potential infringement issues in the current market.

Once the patent claims are received by the computer system, the LLM commences an analysis phase where NLP techniques are applied to decode the technical jargon and complex phraseology that are characteristic of patent documents. This analysis is vital to distinguish the technical features that are central to the patents. Such features may include innovative elements, processes, compositions, or configurations that are unique to the inventions and are legally protected.

Following the recognition of technical features, the LLM proceeds to construct structured claim charts. These charts correlate specific claim elements from the analyzed patent claims with corresponding descriptions, thereby streamlining the task of assessing these claims with respect to their context and relevance.

The infringement analysis distinguishes prospective licensees or potential infringers. Prospective licensees are entities or individuals that might benefit from legally utilizing the patented technology by acquiring a license, while potential infringers are those who might be using the patented technology without proper authorization.

To address these identified entities effectively, the LLM, well-practiced in the nuances of successful licensing campaigns, generates personalized outreach materials. These materials are tailored specifically to each identified prospective licensee or potential infringer, taking into account the intricacies of the patents involved, the nature of the technical features, and the market context of the recipients.

Finally, by harmonizing its operations with marketing platforms and social media sites, the computer system reaches out to the identified prospective licensees or potential infringers. This contact initiative is executed directly through the integrated channels, thus facilitating a targeted and strategic approach to patent licensing and enforcement.

In the context of the patent claims analysis, the step of parsing the claims is to delineate the claimed one implementation's specific elements and limitations. This process involves breaking down each claim into its constituent parts or phrases to pinpoint the exact nature and scope of the claimed subject matter. Every claim is carefully examined to ensure that it sufficiently specifies the technical features that differentiate the claimed one implementation from prior art and define the boundaries of exclusivity sought by the patent applicant.

Parsing the claims encompasses an evaluation of both independent and dependent claims, identifying the preamble, transitional phrases, and the body of each claim. The preamble sets the stage by suggesting the category of one implementation, while the transitional phrases signal the type and extent of protection sought. The body of the claim is scrutinized to extract every element, which can be an apparatus, method step, system component, or material composition, depending on the type of one implementation. Each element is dissected to its most primitive form to comprehend its structure, function, interaction with other elements, and its contributions to the novelty and utility of one implementation. Similarly, limitations within the claims are identified, which may impose boundaries on the claim scope, such as specific configurations, arrangements, dimensions, or process conditions.

As individual elements and limitations are identified, they are compared with the contents of the patent specification, specifically the detailed description section. This comparison is to determine if each element and limitation has substantive support within the disclosed embodiment(s) of one implementation. This ensures adherence to USPTO patent standards, which require that the claims are fully and particularly described in the detailed description, enabling a person skilled in the art to make and use one implementation. The detailed description serves as the foundation upon which the claims are constructed, providing the necessary exposition and context for the claimed one implementation.

The detailed description often elaborates on the structure, characteristics, and workings of one implementation in comprehensive detail, showing how the elements and limitations of the claims are instantiated in practical embodiments. It also explains variations and alternative embodiments that fall within the scope of the claims, illustrating the full breadth and applicability of one implementation.

Furthermore, when prior claimed elements or features are referenced in subsequent claims, the detailed description should adequately reveal these elements or features in a manner that elucidates their purpose, advantages, and technical significance. The description should also illuminate any innovations over the prior art that are embodied within these features. It is that the detailed description be sufficiently thorough to support the claims, as it is from this narrative that the true scope and substance of the patent are discerned and legally established.

Generating claim charts involves a process whereby a table is formulated. Within this table, there are at least two columns. One column is dedicated to housing the verbatim text of the patent claims—these are the potentially and non-obvious technical features, processes, or designs for which protection is sought or has been granted. On the adjacent side, another column is purposefully left blank at the outset. This space is reserved for the eventual entry of correlating features or attributes that are found in existing or forthcoming products, services, or processes in the marketplace.

During this phase, rows are established, each corresponding to a separate claim or a part thereof if the claim is complex and requires breaking down into more granular elements for detailed analysis. The act of populating the second column refers to the mapping process. Here, the aim is to align real-world offerings with the specified elements of the patent claims. This exercise is pivotal in determining possible instances of infringement.

Ultimately, the creation of claim charts is not merely an exercise in tabulation. Instead, it's an instrumental analytical procedure that lays the groundwork for an informed infringement analysis, through which actual or potential infringements can be identified by comparing how market products embody, utilize, or otherwise reflect the technical features as claimed. This procedure necessitates a deep understanding of both the patent claims and the technical aspects of products or services under scrutiny. It's a comparative analysis requiring rigorous attention to detail to disclose the overlap between claimed inventions and industry implementations.

In accordance with one aspect of the described system, the identification of prospective licensees involves the deployment of a Fast Approximate Nearest Neighbor Search Algorithm (FAISS-based) similarity search. This specific aspect of the system's functionality allows for the efficient location of companies whose offerings—be they products or services—closely align with the patented technology in question.

To achieve this, the large language model that has processed and analyzed the patent claims is then utilized to effectuate the FAISS-based similarity search. The process begins with the system's extraction of technical features from the set of patent claims that have been received and analyzed (S400, S402). Those extracted features serve as search parameters within a vast and dynamic database of company products and services. This database, which is continuously updated, includes but is not limited to metadata, technical specifications, and product descriptions sourced from open databases, company websites, and proprietary data repositories.

The FAISS algorithm is specifically designed to work with high-dimensional vectors and is optimized for efficiency on large scale datasets, making it highly suitable for performing rapid similarity searches in such a complexity-rich domain. By converting technical features into vectors, the model computes similarity scores between these feature vectors and the vectors representing the products or services in the database.

Once the similarity scores are calculated, a threshold is applied to determine a match; a company is considered a prospective licensee if its product or service vector has a similarity that meets or exceeds the established threshold when compared to the patented technology's feature vector. This process ensures that only companies with closely aligned products or services are identified as potential licensees (S408).

The companies that are thus identified are ranked according to their similarity scores, and this ranked list serves as the initial screening process for potential licensing opportunities. The highest ranked companies are considered the most relevant and are thus prioritized for outreach. The mechanism in place is capable of distinguishing between various levels of relevance and can be adjusted depending on the desired level of market penetration or exclusivity of licensing efforts.

Furthermore, additional context such as market segment, size of the company, geographic presence, or known research and development initiatives can be taken into account to refine the search and the subsequent outreach strategy. This comprehensive approach ensures that the entities with the highest potential for successful licensing arrangements are systematically and efficiently identified.

The disclosed technology improves upon existing methods by incorporating a system and method for ranking potential licensees based on a likelihood of interest in and an ability to commercialize the technology in question. This system prioritizes outreach and licensing efforts to optimize efficiency and increase the probability of successful licensing agreements.

Upon receiving a set of patent claims from a family of patents (S400), the computer system leverages natural language processing techniques implemented by a large language model (LLM) to analyze the patent claims (S402). The analysis is focused on identifying technical features that are central and unique to the patent and that may be of interest to potential licensees seeking new technologies to enhance their product portfolio.

Once products or services that embody the features of the patent claims are identified, the system proceeds to rank the respective manufacturers or service providers. The ranking is based on two primary criteria: the prospective entities' likelihood of interest in the patented technology, and their ability to commercialize the technology successfully, which collectively indicate the entities' potential as licensees.

Determining the likelihood of interest involves assessing various factors, including but not limited to an entity's current market position, their research and development activities, their patent portfolio, and their historical activity with regards to in-licensing technology. Entities with a strong record of in-licensing and integrative capabilities, for example, may be ranked higher given their demonstrated willingness to adopt externally developed innovations.

The ability to commercialize the technology is measured by analyzing an entity's resources, market access, production capabilities, distribution networks, and financial stability. Entities with supply chains, efficient production processes, and strong sales channels are considered better candidates for rapidly and effectively bringing the patented technology to market.

Potential licensees that high on both parameters are ranked accordingly and are considered prime candidates for outreach. The final ranked list of prospective licensees or potential infringers aids in identifying parties that should be approached first, ensuring that licensing efforts are directed towards entities most likely to be interested in and capable of commercializing the technology, thereby potentially reducing the time and resources spent on non-productive negotiations.

One implementation provides for a computer-implemented method for creating personalized outreach materials which includes the step of generating email templates and advertising copy utilizing natural language processing (NLP) models. These models are specifically fine-tuned based upon data derived from successful licensing campaigns. Such models employ machine learning techniques, allowing them to analyze vast amounts of textual data from previous campaigns that have resulted in successful license agreements or settlements. By learning from patterns, including language, tone, and structure that led to positive outcomes, these models can then generate customized outreach materials designed to engage prospective licensees or potential infringers.

The process involves using a curated dataset from successful licensing initiatives to train the NLP models, ensuring that the generated content is reflective of strategies that have historically yielded favorable licensing results. Once trained, the NLP models can process the characteristics of patent claims and the identified technical features of a specific patent portfolio as input. These characteristics and features are part of the information that was initially received by the computer system and subsequently analyzed.

In this manner, the NLP models take into consideration not only the linguistic aspects of successful communication but also the substantive content that must be conveyed to connect the technical aspects of the patent claims to the potential value for the prospective licensee or the potential risk for the infringer. The output, therefore, is personalized email templates and advertising copy which are not generic but tailored to the recipient's context, integrating both persuasive elements from prior campaigns and relevant patent-specific details. This personalized approach is aimed to increase the likelihood of successful engagement by resonating with the recipient's interests and concerns.

By generating these personalized outreach materials, one implementation ensures a more targeted and effective approach to licensing and infringement resolution. The method leverages the specificity of each case, thereby reducing the one-size-fits-all communications that often yield lower engagement rates and dilute the persuasive message intended by the patent holder. The result is an optimal blend of data-driven content creation and human-like language generation capabilities, aimed at facilitating successful licensing outcomes for patent holders.

The disclosed computer system and method enhance the efficiency and effectiveness of identifying and reaching out to prospective licensees by integrating web scraping techniques and professional network integrations. This system significantly streamlines the process of generating licensing leads and initiating contact for the purpose of monetizing intellectual property rights.

Upon the completion of this infringement analysis, the system identifies entities that are likely using the patented technology without permission-prospective licensees if engaging in the licensed use of the technology is desired, or potential infringers if unauthorized use is suspected (S408). Once these entities have been pinpointed, the system employs its fine-tuned LLM, configured with insights from previous successful licensing efforts, to generate personalized outreach materials for each prospective licensee or potential infringer (S410). This level of personalization is aimed at enhancing the chances of a successful engagement with the target audience.

To augment the engagement strategy, the disclosed system includes a functionality that extends beyond the internal analysis of patent data. It is further informed by a approach that involves retrieving contact information for decision-makers within the prospective licensee companies. This retrieval process employs web scraping techniques, which scour the internet to extract pertinent contact details from various sources that may include corporate websites, patent databases, and other relevant online platforms. Furthermore, the system integrates with professional networking sites, harnessing these platforms' vast repositories of professional information to pinpoint individuals who are most likely responsible for making decisions related to licensing activities in their respective organizations.

The synergy between web scraping technologies and professional network data culminates in compiling a comprehensive database of individuals with the authority and influence to negotiate and secure licensing agreements. With this information at its disposal, the computer system can execute a targeted approach, reaching out to these decision-makers through a blend of personalized correspondence and strategic communication channels. The system's integration with marketing platforms and social media sites (S412) facilitates a wide-reaching and multi-channel outreach campaign, which is designed to successfully establish contact with these individuals, thereby laying the groundwork for potential licensing negotiations, and ultimately, fostering the commercialization and broader dissemination of technological innovations encapsulated within the family of patents under consideration.

One implementation further comprises conduct of a business enhancement analysis for each prospective licensee. The business enhancement analysis involves examining and understanding the current product lines or services of a prospective licensee to identify areas where the patented technology can be utilized to improve or augment existing products or services or to inspire new product developments. This includes an in-depth investigation into the prospective licensee's market segments, competitive environment, and innovation pathways. The goal of the business enhancement analysis is to create a clear, compelling case for how the adoption of the patented technology can lead to enhanced value creation and competitive advantage for the prospective licensee.

Once potential applications are identified, the analysis further entails an evaluation of the prospective licensee's capability to integrate the patented technology. This includes a review of their technical know-how, manufacturing abilities, and the readiness of their supply chain and distribution networks. Additionally, the analysis may also cover a financial assessment to estimate the potential economic impact of adopting the patented technology, including projected return on investment (ROI), cost savings, and revenue generation opportunities.

The outcome of the business enhancement analysis is supplemented with structured claim charts that detail the fit between the patented technology and the licensee's potential applications. These charts act as visual aids in further discussions with the prospective licensee, illustrating the alignment between the technical features of the patented technology and the identified opportunities within their current or future product or service offerings.

To begin with, one aspect of the analysis is to estimate potential cost savings. By integrating the patented technology, an organization may be able to streamline existing processes, reduce the need for manual labor, or eliminate the use of less efficient technologies. The adoption may also lead to a decrease in raw material consumption or a reduction in energy usage due to more efficient performance characteristics inherent in the patented technology. The estimation of cost savings takes into account these factors and more, providing a clear financial picture regarding how the implementation of the patented technology can affect the bottom line.

Another component of the business enhancement analysis involves projecting revenue increases. The patented technology may allow for the development of new products or enhancement of existing products, which could tap into unmet market needs or better satisfy existing demands. Alternatively, the improved performance or new features provided by the patented technology could facilitate an increase in market share or allow the organization to command a premium price. Projections consider the market's responsiveness to enhanced or new offerings, the potential expansion into new market segments, and the overall impact on sales volumes.

Furthermore, the analysis extends to the evaluation of competitive advantages that might be realized through the patented technology's implementation. These competitive advantages could encompass a variety of factors such as strengthening the organization's market positioning, enhancing brand reputation due to superior technology, or achieving quicker time-to-market with new or improved products. By holding the rights to a patented technology, an organization may also be able to establish barriers to entry for competitors or create a unique niche that is difficult for others to replicate.

Moreover, the assessment may include a nuanced understanding of the patented technology's role in the organization's strategic objectives and how it aligns with its long-term vision. This alignment could be for decision-making processes, especially concerning investments in technology deployment and R&D initiatives.

The business enhancement analysis thus covers a comprehensive review of several dimensions-cost savings, revenue increases, and competitive advantages—to equip stakeholders with relevant data points necessary for informed decision-making regarding the adoption and utilization of the patented technology. By quantifying these benefits, the analysis aids in drawing a correlation between the technical merits of the patented one implementation and tangible business outcomes.

An exemplary Python code outline uses AI to identify licensing candidates based on product proximity to patent claims and optimizes licensing campaigns using a CRM:

```
class LicensingAISystem:
  def _{——}init_{——}(self):
    self.vectorizer = TfidfVectorizer( )
    self.crm = CRM( )
  def analyze_patent_claims(self, patent_claims):
    “““Use LLM to analyze and extract key features from patent claims”””
    response = openai.Completion.create(
      engine=“text-davinci-002”,
      prompt=f“Extract key technical features from these patent claims:\n\n{patent_claims}”,
      max_tokens=200
    )
    return response.choices[0].text.strip( )
  def analyze_product(self, product_description):
    “““Use LLM to analyze and extract key features from product description”””
    response = openai.Completion.create(
      engine=“text-davinci-002”,
      prompt=f“Extract key technical features from this product description:\n\n{product_description}”,
      max_tokens=200
    )
    return response.choices[0].text.strip( )
  def calculate_similarity(self, patent_features, product_features):
    “““Calculate similarity between patent and product features”””
    tfidf_matrix = self.vectorizer.fit_transform([patent_features, product_features])
    return cosine_similarity(tfidf_matrix[0:1], tfidf_matrix[1:2])[0][0]
  def identify_licensing_candidates(self, patent_claims, products_data):
    “““Identify potential licensing candidates based on product proximity to patent claims”””
    patent_features = self.analyze_patent_claims(patent_claims)
    candidates = [ ]
    for product in products_data:
      product_features = self.analyze_product(product[‘description’])
      similarity = self.calculate_similarity(patent_features, product_features)
      if similarity > 0.7: # Threshold for considering a product as a potential candidate
        candidates.append({
          ‘company’: product[‘company’],
          ‘product’: product[‘name’],
          ‘similarity_score’: similarity
        })
    return sorted(candidates, key=lambda x: x[‘similarity_score’], reverse=True)
  def optimize_licensing_campaign(self, candidates):
    “““Use CRM to optimize the licensing campaign”””
    for candidate in candidates:
      # Add candidate to CRM
      self.crm.add_lead(candidate[‘company’], candidate[‘product’], candidate[‘similarity_score’])
    # Generate campaign strategy
    campaign_strategy = self.crm.generate_campaign_strategy( )
    return campaign_strategy
  def run_licensing_campaign(self, patent_claims, products_data):
    “““Main function to run the entire licensing campaign process”””
    candidates = self.identify_licensing_candidates(patent_claims, products_data)
    campaign_strategy = self.optimize_licensing_campaign(candidates)
    print(“Top Licensing Candidates:”)
    for candidate in candidates[:5]: # Print top 5 candidates
      print(f“Company: {candidate[‘company’]}, Product: {candidate[‘product’]}, Similarity:
{candidate[‘similarity_score’]:.2f}”)
    print(“\nCampaign Strategy:”)
    print(campaign_strategy)
```

The code: 1. Uses LLM to analyze patent claims and product descriptions, extracting key technical features; 2. Calculates similarity between patent claims and product features using TF-IDF and cosine similarity; 3. Identifies potential licensing candidates based on the similarity score; and 4. Integrates with a CRM system to optimize the licensing campaign. The ‘LicensingAISystem’ class contains methods for: Analyzing patent claims and product descriptions using LLM; Calculating similarity between patent and product features; Identifying licensing candidates based on similarity scores; and Optimizing the licensing campaign using a CRM system.

The ‘run_licensing_campaign’ method orchestrates the entire process, from identifying candidates to generating a campaign strategy. Integrating with email marketing platforms and social media advertising APIs to execute outreach campaigns involves the utilization of various electronic communication services and online advertising tools to facilitate direct engagement with prospective licensees or potential infringers. The system employs integration techniques to synchronize with renowned email marketing platforms, leveraging their infrastructure to disseminate personalized outreach materials effectively. These materials are crafted using insights gleaned from the large language model's analysis of successful licensing campaigns.

Simultaneously, the system exploits the capabilities of social media advertising APIs, which provide it with the ability to place highly targeted advertisements. These advertisements are designed to appear in the feeds of identified potential infringers or licensees, thereby increasing the likelihood of capturing their attention and prompting them to consider the patent claims in question. The strategic deployment of ads through social media APIs ensures that the outreach is not only extensive but also tailored to the interests and behaviors of the target audience, thereby amplifying the chances of engagement.

The operations of integrating with email marketing platforms and sending out targeted social media advertisements are performed in compliance with the relevant data protection and privacy laws. This initiative is part of the AI-driven infringement analysis process, where the system's specialized components have already compared technical features of the family of patents to existing products or services in the market. By identifying matches or similarities, the system has earmarked entities that may either benefit from a license or could potentially be infringing on the patent rights.

Contact with these entities is not done indiscriminately but is the result of a and selection process. The outreach campaigns are executed with a level of personalization that reflects an understanding of the specific technical and business contexts of the potential licensees or infringers. This not only increases the efficacy of initiating contact but also demonstrates a level of professionalism and respect for intellectual property that can pave the way for fruitful negotiations and resolutions.

In one embodiment of one implementation, the computer system further comprises functionality for monitoring response rates and engagement metrics resulting from the personalized outreach campaigns. This monitoring is as it provides valuable feedback on the effectiveness of the outreach materials and the overall success of the licensing campaigns.

The computer system is configured to collect and analyze data related to how recipients of the outreach materials interact with the content. These interactions may include opening emails, clicking on links provided within the materials, the duration of time spent reviewing the content, and any follow-up actions taken. Such metrics are recorded and can be visualized or reported in various formats, providing insights into user engagement and interest.

By gathering these metrics, the system can ascertain which aspects of the outreach materials are most effective at garnering the attention of potential licensees or infringers. In addition, the system can identify patterns or commonalities among those who respond positively, which can then be used to fine-tune future outreach attempts.

The analysis of response rates and engagement metrics enables the computer system to continuously improve its outreach strategies. For instance, the system may learn that certain technical features highlighted within the claims resonate more with certain types of recipients, or that certain industries are more likely to engage with particular types of outreach materials.

Furthermore, the system is capable of automating parts of the follow-up process based on the data collected. If a recipient shows a high level of engagement but does not take the expected steps, the system may trigger a follow-up message or alert a human operator to take further action. This functionality ensures that high-potential leads are nurtured effectively and maximizes the chances of successful licensing agreements or infringement resolutions.

Overall, the addition of monitoring response rates and engagement metrics into the system plays a pivotal role in refining the patent monetization and enforcement strategies. It provides a feedback loop that not only measures the success of the outreach campaigns but also informs future iterations, making the system more adaptive and intelligent in its approach to patent licensing and enforcement.

In one implementation, refinement of the outreach approach and messaging is based upon monitored response rates and engagement metrics, thereby creating a feedback loop that enhances the effectiveness of communication strategies. This step involves the use of data analytics and machine learning algorithms, which process the data related to how prospective licensees or potential infringers respond to the initial contact made through various marketing platforms and social media sites.

The computer system is configured to monitor performance indicators (KPIs) such as open rates, click-through rates, response times, and other relevant metrics that reflect the level of engagement elicited by the outreach materials. These metrics are collected and processed by the LLM, which is programmed to interpret and analyze the effectiveness of messaging and identify patterns, trends, and associations.

Using the insights garnered from the analysis, the LLM then refines the outreach materials. This refinement process involves adjusting the language, tone, and structure of the communication to better align with the interests and needs of the recipients. Tailoring the messaging in this manner may result in more compelling and persuasive outreach materials, thus increasing the likelihood of successful engagement with prospective licensees or potential infringers.

Moreover, the LLM is equipped to perform A/B testing, wherein it generates several variations of the outreach materials and monitors the performance of each variant. This helps to identify the most effective messaging strategies. Constant iteration and optimization are aspects of this refinement process. By continuously updating the outreach based on actual engagement data, the system ensures that the licensing campaigns are increasingly focused and effective over time.

Additionally, the system may utilize the response and engagement data to segment the target audience more effectively. By understanding which segments are more responsive or receptive to certain types of messaging, the LLM can customize future outreach materials to cater to the preferences and interests of specific groups within the target audience. This level of personalization can significantly enhance the relevance of the outreach for each recipient, thereby improving the overall success rate of the licensing campaigns.

In conjunction with conducting an AI-driven infringement analysis, the large language model also assumes the role of facilitating the generation of preliminary licensing terms. The aim is to align these terms with prevailing industry standards, ensuring an equitable starting point for negotiations while simultaneously reflecting the unique value proposition offered to each potential licensee. This value-driven approach is tailored to the characteristics of each entity, recognizing the distinct benefits that licensing the patented technology may confer upon them.

By blending the understanding of the intrinsic value of the patent claims with a comprehensive evaluation of industry norms, the system devises a set of initial licensing conditions. This customized proposition considers multiple facets such as the scope of the patent, the extent of its application in the prospective licensee's products or services, and the competitive advantage it could grant within the market. The system places emphasis on crafting terms that are attractive and fair, fostering a productive dialogue aimed at securing a licensing agreement.

This licensee-centric strategy not only accelerates the licensing process but also ensures that the initial terms of engagement are pertinent and compelling. By acknowledging the diverse capabilities and market positions of potential licensees, the generated terms serve as a strong foundation for subsequent negotiation stages.

The preliminary licensing terms are not static. They serve as a dynamic proposal that can be refined based on feedback from prospective licensees and the evolution of market conditions. The outcomes of the infringement analysis, including the identification of technical features and their correlation to the products or services of potential infringers, guide the adjustment of these terms to align with both the licensors' objectives and the licensees' willingness to engage.

Furthermore, the process of creating preliminary licensing terms is iterative, benefitting from continuous learning as the language model encounters new data from successful licensing campaigns and varied market responses. This data feeds back into the system, enhancing its capability to formulate terms that are not only contextually relevant to the current market but are also predictive of licensing trends, thereby maintaining a competitive edge in the patent licensing domain. The system's ability to adapt to shifting parameters in patent licensing negotiations underscores its utility as a tool for licensors looking to maximize the potential of their intellectual property portfolios.

Within the scope of the disclosed computer-implemented methods for managing and optimizing patent-related activities, where a system comprising both hardware and software is utilized to perform various tasks as delineated in the preceding claims, an additional functional capability is included. This capability entails the facilitation of interactions between patent holders and potential licensees who have been identified as either prospective partners or, conversely, as potential infringers who may be interested in securing licensing agreements to legitimize their use of patented technology.

The system, having been programmed with natural language processing algorithms and particularly fine-tuned large language models, goes beyond the analysis and generation of claim charts. After determining possible infringements based on the technical features extracted from patent claims and comparing these with existing products or services in the market, and subsequently producing personalized outreach materials, the system undertakes a further action. It assists in the logistical coordination of subsequent communications between the patent holders and the prospective licensees.

This additional step operates through an integrated module within the system which is configured to facilitate the administrative aspects of setting up meetings, calls, or other types of interactive sessions. Upon initiation of contact with a prospective licensee or infringer, the system can propose potential meeting times by analyzing calendars associated with both parties, or by issuing interactive prompts to ascertain availability.

The system can send out calendar invites, reminders, or notifications to ensure that both parties are adequately prepared for the upcoming engagement. Its integration with commonly used business communication platforms enables the seamless orchestration of such events, with the system potentially also providing agenda items, discussion points, and relevant claim charts to foster productive dialogue.

This interaction management aspect underscores the comprehensive approach of the disclosed methods—not only identifying and reaching out to prospective licensees but also facilitating the path towards successful licensing agreements by simplifying the process of engagement and reducing the administrative burdens often associated with such negotiations. Through this, the system aids in creating a streamlined approach for the licensing of patents, potentially increasing the efficiency and likelihood of reaching amicable and mutually beneficial agreements between innovating entities and those seeking to utilize their patented technologies commercially.

In another aspect, a method for enhancing patent licensing and infringement analysis using an artificial intelligence system includes: receiving, by a computer system, a set of patent claims from a family of patents; analyzing, using natural language processing techniques implemented by a large language model (LLM) within the computer system, the patent claims to identify key technical features; generating, by the LLM, structured claim charts based on the analyzed patent claims; conducting, by the specialized components of the LLM, an AI-driven infringement analysis by comparing the key technical features to products or services in the market; identifying, based on the infringement analysis, prospective licensees or potential infringers; generating, using the LLM fine-tuned on successful licensing campaigns, personalized outreach materials for each prospective licensee or potential infringer; and contacting the prospective licensees or potential infringers through integration with marketing platforms and social media sites.

Implementations can include one or more of the following:
a. parsing the claims to identify individual elements and limitations.
b. creating a table with claim text in one column and space for mapping to potential products in another column.
c. using a FAISS-based similarity search to find companies whose products or services align with the patented technology.
d. ranking potential licensees based on likelihood of interest and ability to commercialize the technology.
e. generating email templates and advertising copy using natural language processing models fine-tuned on successful licensing campaigns.
f. retrieving contact information for decision-makers at prospective licensee companies using web scraping techniques and professional network integrations.
g. conducting a business enhancement analysis for each prospective licensee to identify potential applications of the patented technology within their product line or services.
h. estimating potential cost savings, revenue increases, or competitive advantages that could result from implementing the patented technology.
i. integrating with email marketing platforms and social media advertising APIs to execute outreach campaigns; monitoring response rates and engagement metrics from the outreach campaigns; and refining the outreach approach and messaging based on the monitored response rates and engagement metrics.
j. generating preliminary licensing terms based on industry standards and the specific value proposition for each potential licensee.
k. assisting in scheduling meetings or calls between patent holders and interested licensees.
l. using data from the centralized knowledge base capture outcomes and feedback from licensing efforts for continuous model refinement and strategy optimization.
m. utilizing a dynamic Mixture of Experts (MoE) system to route specific analysis tasks to specialized models; decomposing the task into sub-tasks and routing each sub-task to the most appropriate expert or model based on semantic similarity.
n. generating synthetic data based on observed licensing patterns to enhance the system's ability to handle emerging tasks.
o. implementing an incentive-based user ecosystem that rewards quality contributions to improve the patent licensing process.

The above implementation introduces a sophisticated artificial intelligence system to revolutionize the process of patent licensing and infringement analysis. Leveraging natural language processing within a large language model, the system adeptly organizes patent claims, creating structured claim charts for easy comprehension. It further excels at matching product features in the marketplace to patent claims, streamlining the identification of possible licensees or infringers. Additionally, it aids in the preparation of tailored communication for licensing opportunities, incorporates web scraping for data collection, seamlessly interacts with multiple platforms for outreach, and supports negotiation by generating licensing terms and facilitating meetings. A central knowledge repository ensures the continuous refinement of strategies, while synthetic data and a rewarding user ecosystem enhance overall system performance and the licensing process.

In embodiments of one implementation, a centralized knowledge base is employed to capture comprehensive outcomes and feedback resultant from the licensing endeavors. This knowledge base will serve as a repository of information to enhance the strategies for outreach and engagement for the licensing of the family of patents.

Furthermore, feedback, being a component in refining processes, is integrated into the knowledge base. Feedback may be collected from both internal sources, such as the performance of the licensing team, and external sources, such as the response from contacted entities. The receptiveness to personalized outreach materials, speed to resolution, or satisfaction with the terms of an agreement are examples of valuable feedback metrics. This data is then processed using the same or similar LLM techniques that underlie the other operations of the system, which allows the generated data to contribute to the further refinement of every other step in the process, from analyzing claims to generating personalized outreach materials.

By assimilating these data points, the artificial intelligence within the computer system can progressively refine its understanding of technical features needed by market entities, learn with more nuance the tendencies conducive to successful licensing, and predict with increasing accuracy the potential challenges that may arise during infringement analysis.

The knowledge base thus becomes not only an archive but a strategic tool, self-enhancing through iterative learning and data collection. The outcome is an optimized approach to managing and monetizing intellectual property assets, making each step in the process more effective over time as it adapts to the rich contextual information accumulated within the centralized knowledge base. Such capabilities potentially simplify the complexities of patent licensing and infringement management for entities relying on intellectual property for business advantages.

The system further comprises specialized components within the LLM that conduct an AI-driven infringement analysis (S406). This analysis compares the identified technical features from the claims to existing products or services, assessing whether these market offerings potentially utilize the patented technology without authorization.

Lastly, the prospective licensees or potential infringers are contacted through various marketing platforms and social media sites (S412). This outreach is integrated with the system to ensure a streamlined and efficient communication process, tailored to the preferences and behaviors of the recipients.

An aspect of this system is the utilization of data from a centralized knowledge base for continuous model refinement and strategy optimization. This knowledge base collects data from various sources including historical patent litigation cases, licensing agreements, patent claim constructions, and prior art references. By leveraging this data, the LLM undergoes continuous learning and improvement. As new information is ingested and processed, the model regularly updates its algorithms and heuristics for better accuracy and predictive capabilities. Additionally, the system uses feedback from the market responses to the personalized outreach materials to further polish the IP management strategies.

The results of these ongoing refinements contribute to the strategic decision-making process. For instance, if a certain technical feature is found to be frequently involved in successful licensing campaigns, more emphasis can be placed on this feature during claim chart generation and infringement analysis. Similarly, if certain outreach approaches lead to more positive engagement from potential licensees or infringers, these methods can be prioritized in future communications.

Overall, the described one implementation combines the capabilities of AI in the form of an LLM with the wealth of data available in IP management to provide a robust, intelligent system that can adapt and evolve its strategies for patent enforcement and licensing, thereby optimizing the patent holder's position in the market.

In one implementation, the computer system employs a dynamic Mixture of Experts (MoE) system that functions to enhance the effectiveness and efficiency of analyzing patent claims. Upon receiving the set of patent claims from a family of patents, the MoE system, in conjunction with the large language model, takes on the challenge of dissecting the complexities embedded within the technical and legal language of these claims.

The analysis begins with the MoE system routing specific analysis tasks to a cadre of specialized models, each fine-tuned for optimal performance in recognizing and interpreting distinct aspects of patent claim language and structure. These tasks could range from identifying technical jargon and patent law terminology to recognizing claim dependencies and conclusively understanding the scope of the claims.

Such an approach allows for a tailored analysis of patent claims, ensuring that the nuances and specific domain knowledge required for each claim are adequately addressed. As each specialized model processes its allocated tasks, it provides insights into the technical features that define the patent claims. These insights are not just isolated data points but form an interconnected web of information that lays the groundwork for developing structured claim charts.

Identifying prospective licensees or potential infringers is an part of leveraging intellectual property rights and ensuring that the patented one implementation is adequately protected and monetized. The identification process commences by decomposing the overarching task into several discrete, more manageable sub-tasks. This ensures a more approach, where each sub-task targets a specific aspect or segment of the market.

The sub-tasks typically include a detailed market analysis to identify entities operating within the technological sphere of the patent claims, a review of potentially infringing products or services, an assessment of the economic value of the patented technology in the context of current market offerings, and an evaluation of the competitive landscape to determine the relative position of each entity with respect to the patented technology.

Once these sub-tasks have been delineated, the computer system can effectively identify the most appropriate experts or computational models to handle each one. The matching process is based on semantic similarity; this involves comparing the content and context of each sub-task with an extensive database of expert profiles and model capabilities. An expert might be a legal professional with specialized knowledge in a particular technological domain or a patent analyst proficient in competitive intelligence.

Alternatively, a model could be an artificial intelligence algorithm programmed to sift through large datasets to find patterns or a machine learning model trained on patent data to predict potential licensing opportunities based on previous successful licensing campaigns.

By routing each sub-task to the entity with the highest semantic similarity score, the computer system ensures that each sub-task is handled by an expert or a model that is most likely to understand the subtleties and complexities involved, thus leading to a more accurate and efficient identification process.

The synthesis of the findings from these sub-tasks in turn enables the system to construct a comprehensive picture of the market landscape. This picture highlights entities that are likely to benefit from the patented technology, either because they are currently operating in technological areas closely related to the patent claims or because they are developing products or services that could infringe on the patent. These entities become the prospective licensees or potential infringers.

In accordance with embodiments of one implementation, the computer system further comprises a module for generating synthetic data based on observed licensing patterns. This enhances the system's capability to handle emerging tasks that may arise in the context of patent claims analysis and infringement detection. This synthesized data is generated to reflect the multitude of possible licensing interactions and scenarios that could emerge from new technology trends or shifts in market dynamics.

By observing historical licensing patterns, the system can identify typical licensing parameters such as royalty rates, licensing terms, and common negotiation points between licensees and licensors. Utilizing this information, the synthetic data generation module creates diverse sets of virtual licensing scenarios that are statistically similar to real-world data but do not replicate any specific instance of private or confidential licensing agreements.

This synthetic data serves multiple purposes. Primarily, it provides a rich dataset for the large language model to train on, beyond what is available in the public domain or within proprietary databases. This allows the system to predict potential outcomes of licensing negotiations, disputes, or agreements based on a broader set of variables. The data is particularly useful for fine-tuning the system to recognize nuanced aspects of patent claims and their relevance to an organization's patent strategy, including enforcement or defense.

Additionally, in situations where data is sparse or non-existent—such as for newly granted patents or emerging industries—the synthetic data acts as a proxy to allow the system to infer patterns and trends that inform the licensing strategy. This predictive capacity strengthened by synthetic data is particularly beneficial in industries characterized by rapid innovation cycles, where historical data may quickly become obsolete.

By integrating this capacity into the system, it is ensured that the AI-driven infringement analysis conducted by specialized components of the large language model remains accurate and relevant despite fluctuations in technological and market developments. Moreover, the synthetic data facilitates a more and informed approach to generating personalized outreach materials for potential licensees or infringers identified in the infringement analysis. The enhanced understanding of likely negotiation outcomes and stakeholder behavior provided by the synthetic data can significantly improve the effectiveness of the outreach strategy, hence potentially increasing the success rate of licensing campaigns.

In summary, the addition of a synthetic data generation module extends the capabilities of the computer system in simulating and understanding a comprehensive range of intellectual property licensing scenarios, thereby empowering patent holders with tools for strategic management of their patent portfolios.

One implementation further encompasses an incentive-based user ecosystem designed to reward quality contributions that enhance the efficacy of the patent licensing process. Within this ecosystem, individuals or entities that provide valuable input or modifications are recognized and compensated, thereby fostering a community of collaboration and continuous improvement.

Contributions that are deemed valuable can include, but are not limited to, providing accurate infringement evidence, suggesting potential licensees who are highly relevant but previously unidentified, improving the natural language processing algorithms used by the large language model, or submitting high-quality structured claim charts that increase the comprehensiveness of the patent claims analysis. Incentives for such contributions may be formulated in various ways, including, but not limited to, monetary rewards, access to premium features within the system, recognition within the ecosystem through leaderboards or badges, or preferential rates on licensing transaction fees.

Participants within the user ecosystem are motivated to maintain the integrity and quality of contributions by a reputation system that takes into account the quality and impact of each participant's contributions over time. The reputation system includes a feedback loop wherein other participants can endorse or critique contributions, thereby providing a peer-review mechanism that encourages accuracy and discourages the submission of low-quality or irrelevant information.

The user incentive system is implemented via a rewards algorithm that allocates points or credits based on parameters such as the novelty of the contribution, the effort required to produce the contribution, the contribution's usefulness as measured by its uptake and application in improving patent claim analysis or successful infringement identification, and the degree of expertise demonstrated by the contributing participant. The system also employs machine learning techniques to continuously analyze participant behavior and contribution outcomes to refine the reward mechanism, ensuring that it evolves to meet the dynamic needs of the patent licensing process and the participants engaged in it.

As part of the reward process, claim charts generated by participants that significantly improve the understanding or scope of the original claims may be incorporated into the system's database. These enhanced structured claim charts can subsequently be used as reference materials by the large language model or by other ecosystem participants, thus perpetually improving the system's analytical capabilities and the robustness of infringement analyses conducted therein.

Moreover, the integration with marketing platforms and social media sites, as specified in claim S412, is leveraged not only for outreach to prospective licensees and potential infringers but also to disseminate quality contributions made by participants. Such public acknowledgment serves as an additional incentive for participants to provide high-quality contributions and is instrumental in building their reputation within the ecosystem.

It should be noted that while the detailed description above focuses on a singular embodiment incorporating an LLM, alternative embodiments could utilize different AI systems or configurations suitable for performing similar tasks. All such embodiments and variations are considered within the scope of one implementation, provided they fall within the breadth and scope of the appended claims.

Although one implementation has been described with reference to specific embodiments, it will be understood by those skilled in the art that numerous modifications and variations are possible. All such modifications and variations are intended to be included within the scope of one implementation as defined by the appended claims. In the claims, means-plus-function clauses are intended to cover the structures described herein as performing the recited function and not only structural equivalents but also equivalent structures.

1. A method, comprising:
receiving by a computer a user query with a document;
generating one or more search terms or claims from the document;
automatically extracting one or more figures from the document and analyzing the one or more figures and associated figure text using a visual multi-modal large language model (LLM) identification including encoders that embed images and words into vector representations, wherein the visual multimodal LLM is trained on embedded images and words to recognize the one or more figures in the document and annotations in the one or more figures to identify a part list from the one or more figures using the LLM and generating a set of references for at least one figure;
performing a search to locate data responsive to the query, the document, the one or more figures and the set of references;
chaining the located search data to augment the user query with the document, the one or more figures, and the set of references; and
applying the LLM to generate a response based on the one or more search terms or claims for context and describing one or more references in the one or more figures.

2. The method of claim 1, comprising identifying image objects embedded within the document and saving the objects as separate image files and differentiating the figure caption or text from other content as a brief description of the figure using the LLM.

3. The method of claim 1, comprising applying a visual language model to the extracted image to identify and label parts within technical drawings and diagrams; generating a brief description by extracting figure captions or nearby text associated with the image; and generating a detailed description section incorporating the extracted images, assigned brief descriptions, and labeled image parts.

4. The method of claim 1, comprising interacting with the LLM in a browser-based user interface.

5. A method of processing a document, comprising:
receiving a query with the document and responding to the query by identifying with a large language model (LLM) one or more decisions or claims in the document, wherein the LLM includes encoders that embed images and words into vector representations;
searching and retrieving one or more references applied to the one or more decisions or claims;
analyzing one or more references and applying one or more rules to traverse the at least one decision or one claim; and
generating a response by chaining the references to the query and providing one or more LLM machine reasoned arguments to traverse the decision or claim, wherein the LLM is a reasoning LLM that generates one or more artificial intelligence context-sensitive texts using a transformer with a decoder that produces a text expansion to provide the context-sensitive text based on first and second texts by applying generative artificial intelligence with normalization and tokenization with zero-shot, one-shot or some-shot generation of the one or more artificial intelligence context-sensitive texts from the first and second texts, wherein the transformer receives a stream of tokens with an attention mask at one or more self-attention layers, and a causal mask is used for the text tokens.

6. The method of claim 5, wherein the reasoned argument is generated by a combination of a machine language model coupled to one or more machine reasoning models.

7. The method of claim 5, comprising querying a database to retrieve history data for a decision maker and analyzing the history data in generating the one or more machine reasoned arguments; and searching a database to identify a rejection and applying an argument from the rejection.

8. The method of claim 5, wherein generating the response comprises:
adapting language from a prior application; and
modifying an argument from the prior application to address the rejection.

9. The method of claim 10, comprising using the LLM to optimize licensing of the application with claim charts and a Customer Relationship Management system, further comprising: analyzing with the LLM a set of claims to identify technical features; generating charts based on the claims; implementing a dynamic Mixture of Experts (MoE) system with a FAISS-based gating mechanism to route specific analysis tasks to specialized AI models; decomposing, by the MoE system, the analysis task into sub-tasks and dynamically routing each sub-task to a selected expert model based on semantic similarity; conducting, by the specialized models, an AI-driven analysis by comparing the technical features to products or services in the market; generating using the LLM trained with prior campaign data personalized outreach materials for each prospect; initiating contact with the prospect through integration with email marketing platforms and social media sites; and continuously updating the AI performance by retraining the specialized models using captured data.

10. A method, comprising:
receiving a query with a document and extracting one or more uses using a large language model (LLM) including encoders that embed images and words into vector representations;
identifying prospects based on a search and chaining the one or more uses and the document to the query as input to the LLM; and
crafting tailored outreach materials using the LLM providing one or more artificial intelligence context-sensitive texts using a transformer with a decoder that produces a text expansion to provide the context-sensitive text based on first and second texts by applying generative artificial intelligence with normalization and tokenization with zero-shot, one-shot or some-shot generation of the one or more artificial intelligence context-sensitive texts from the first and second texts, wherein the transformer receives a stream of tokens with an attention mask at one or more self-attention layers, and a causal mask is used for the text tokens.

11. The method of claim 10, further comprising creating a canvas for the application and the prospects.

12. The method of claim 10, further comprising identifying a contact list to communicate with the prospects using chat, email, or social media channel.

13. The method of claim 10, further comprising providing a customer relationship management (CRM) system to track prospects.

14. The method of claim 10, comprising:
receiving, by a computer system, a set of patent claims from a family of patents;
analyzing, using natural language processing techniques implemented by the LLM within the computer system, the patent claims to identify key technical features;
generating, by the LLM, structured claim charts based on the analyzed patent claims;
conducting, by the specialized components of the LLM, an AI-driven infringement analysis by comparing the key technical features to products or services in the market;
generating, using the LLM fine-tuned on successful licensing campaigns, personalized outreach materials through integration with marketing platforms and social media sites.

15. A method, comprising:
receiving a query and a publication with one or more images;
generating one or more search terms or claims from the publication;
automatically extracting the one or more images from the publication using a visual large language model (LLM) including encoders that embed images and words into vector representations;
automatically assigning brief descriptions to the extracted one or more images based on the one or more images;
applying the visual LLM to the extracted one or more images to identify and label reference signs for one or more images;
generating claims based on the publication; and
applying the language model to generate a specification based on the claims, one or more images, brief descriptions.

16. The method of claim 1, comprising generating a plan to respond to the query; iteratively searching and analyzing multiple sources related to the query; reasoning about the gathered information to refine the plan; and rendering a response.

17. The method of claim 1, comprising analyzing the content of the document using a transformer; extracting information from the document; performing a web search to supplement the extracted information; and synthesizing a response that combines data from the document and web search results.

18. The method of claim 1, comprising analyzing the query using a transformer to determine context and intent; performing a search based on the analyzed query; retrieving information from one or more references; and synthesizing the retrieved information using the LLM to generate a response with citations to the one or more references in the response.

19. The method of claim 1, comprising providing one or more artificial intelligence context-sensitive texts using a transformer with a decoder that produces a text expansion to provide the context-sensitive text based on first and second texts by applying generative artificial intelligence with normalization and tokenization with zero-shot, one-shot or some-shot generation of the one or more artificial intelligence context-sensitive texts from the first and second texts, wherein the transformer receives a stream of tokens with an attention mask at one or more self-attention layers, and a causal mask is used for the text tokens.

20. The method of claim 1, comprising receiving, via an application programming interface (API), the query and autonomously analyzing, using the LLM, a plurality of sources to answer the query and generating, based on the analysis, a response across multiple domains.
